(19) United States
(12) Patent Application Publication
(10) Pub. No.: US 2003/0215357 A1
(43) Pub. Date: Nov. 20, 2003

(54) Automated processing system and method of using same

(76) Inventors: Nigel Malterer, St. Charles, MO (US); Mark Mertz, St. Charles, MO (US); Russell Leeker, Fenton, MO (US)

Correspondence Address: Box IP Department, 500 North Broadway, Suite 2000, St. Louis, MO, 63102, US

(21) Appl. No.: 10/438,958

(22) Filed: May 15, 2003

Related U.S. Application Data
(60) Provisional application No. 60/380,640, filed on May 15, 2002.

(51) Int. Cl. G01N 1/00

(52) U.S. Cl. 422/50; 422/63

(57) ABSTRACT

An automated processing system, particularly for use in biotechnology, which is modular in construction and allows for a wide variety of instruments to be inserted and/or removed without having to reprogram the system and methods of using such a system. This may be called “plug and play” functionality. The system may be portable without disassembly and have a generally vertical arrangement so as to utilize less useful lab space than a horizontally arranged system.

### CROSS REFERENCE TO RELATED APPLICATIONS

This application claims priority to U.S. Provisional Application Serial No. 60/380,640 filed May 15, 2002 the entire disclosure of which is herein incorporated by reference.

### BACKGROUND OF THE INVENTION

1. Field of the Invention

This disclosure relates to the field of automated processing systems. In particular, to automated processing systems which are arranged vertically.

2. Description of the Related Art

While the industrial revolution may have harkened the introduction of the assembly line, only recently has robotic processing come forward as a tool for use on those assembly lines. Many assembly lines today utilize robots and assembly machines in order to automate processes that used to take hundreds of human hours to perform. Robots have the advantage that they never need to sleep, never need to take a break, and can run a task or wait regardless of the time of day. For these reasons, more and more processing is being performed by robots.

One area is which robotic automation has not really taken hold is in the field of biotechnology research. While many individual process involved in biotechnological procedures may utilize robotic or computerized devices either on their own or in conjunction with a human operator, these processes act in a standalone fashion generally with a human operator placing the sample in the machine, waiting for the process to be completed, and then transferring the sample to the next machine.

This process is often quite boring for the operator, and is also very inefficient. While the operator may be able to operate multiple machines operating simultaneously, the operator is limited in how many jobs they can perform. Further, there is also a danger that an operator will miss a critical operation or will forget where in the sequence of machines a particular sample is. Still further, many of these processes are highly repetitive as the samples are processed, leaving the operator to repeat the same steps hundreds if not thousands of times before sufficient samples have been processed to provide any useful data. For all these reasons the cycling of biological samples through processing is a process which would clearly lend itself to automation.

Currently, some automation procedures have been proposed. One of these utilizes a single robot arm placed in the center of a group of horizontally arranged instruments so that the arm can move the sample between the instruments as each sample completes a stage in the processing. While this process does provide for some automation, the amount of different process steps which can be performed by the arm are limited by the physical space in the horizontal plane which can surround the robot arm. Further, the process is of a predetermined number of fixed steps. The arm is individually calibrated to interact with each instrument present when the system is set up. Therefore, if processing was needed that required the use of a different instrument, even if there was physical space to place the instrument, the arm would need to be completely recalibrated to understand how to interact with that new instrument in conjunction with the old instruments. This means the system is relatively fixed and cannot be readily changed.

This is undesirable for a few reasons. First, it means that the arm generally has a series of dedicated machines associated to its particular process. Therefore, if a particular type of machine was needed in multiple processes, the biotechnology lab would need to purchase duplicates of the machine. so that the machine could be used outside the process, even if it is often idle during the process, or the process is not currently running. This leads to increased expense for the lab, as well as the requirement of additional lab space.

A further problem is that because the arrangement of instruments is fixed, in order to perform a different process utilizing the same instruments, the arm must be completely recalibrated. If the first process is then wanted again, the arm again has to be completed recalibrated back. Therefore, each setup is generally of singular use so efficiency can require using multiple arms, which makes the process yet more expensive. This fixed arrangement also generally requires that the experiment be brought to the machine as the machine is generally not very portable and even if it can move about the floor, may not be able to move between different laboratory areas such as through doorways, or in elevators without having to be dismantled.

### SUMMARY

For these and other reasons known in the art it is desirable to have an automated processing system which is modular in construction and allows for a wide variety of instruments to be inserted and removed without having to reprogram the system. This may be called “plug and play” functionality. It is further desirable to have a system which is portable and can be moved throughout a building without disassembly including moving into elevators and through doorways. It is further desirable to have an automation system whose primary arrangement is vertical so that the system utilizes less useful space in the lab and can therefore be used in smaller locations

Discussed herein, amongst other things is an automated processing system comprising; a shelf support structure including: a network communication infrastructure, a central control system connected to the infrastructure, and a transfer device connected to the infrastructure; and a shelf module including: at least one mechanism for manipulating a physical object provided to the shelf module, and a network interface allowing the shelf module to connect to the network communication infrastructure; wherein each of the shelf modules can be supported by the shelf support structure in such a manner that the network interface connects to the network communication infrastructure; wherein the central control system can automatically recognize the at least one mechanism via the network communication infrastructure once the shelf module is connected to the network communication infrastructure; and wherein the central control system can utilize the transfer device to provide the physical object to the shelf module so that the at least one mechanism can manipulate the physical object.

In an embodiment the physical object may comprises a microtiter plate, a biological sample, a tube, and/or a pipette tip. The shelf support structure may include a cabinet which may or may not include a contained environment.

In an embodiment, the network communication infrastructure comprises a wired network including a connection plug, the network interface comprises a mating connection plug designed to mate with the connection plug, and/or the mating connection plug mates with the connection plug when the shelf module is pushed into the shelf support structure. In another embodiment the network communication infrastructure comprises an Ethernet protocol computer network infrastructure.

In another embodiment, the shelf support structure is designed to support a plurality of the shelf modules in a vertical arrangement, may be a vertical integration platform, and/or the transport device may comprise a vertical lift such as, but not limited to, a vertical conveyor or a robot arm, which may in turn have at least three dimensions of motion. In still another embodiment, the transport device may comprise a robot arm even if it is not a vertical lift.

In still another embodiment, at least one mechanism on the shelf module comprises at least one of, a robot arm, a transfer facilitator, a stack, a carousel, and/or an instrument, and/or the shelf module may include a self-contained environment to that shelf module. The system may include at least one of: an external conveyor, an external storage rack, and an emergency shutoff and/or be able to pass through a 36″ by 84″ doorway without disassembly.

In a still further embodiment, the automated processing system can be mated to a second automated processing system and physical objects can be passed between the automated processing system and the second automated processing system. In such a system the central control system of the automated processing system can also control the central control system of the second automated processing system when the systems are so mated.

In a still further embodiment, there is described, a shelf module comprising: at least one mechanism for manipulating a physical object provided to the shelf module; and a network interface allowing the shelf module to connect to a network communication infrastructure; wherein the shelf module can be supported in a shelf support structure in such a manner that the network interface connects to the network communication infrastructure in the shelf support structure; wherein the shelf module can automatically identify itself to a central control system in the shelf support structure once the shelf module is connected to the network infrastructure; and wherein the shelf module can receive physical objects from a transfer device in the shelf support structure.

### BRIEF DESCRIPTION OF THE FIGURES

FIG. 1 provides a side elevational view of a first embodiment of a shelf support structure including four shelf modules.

FIG. 2 provides a front perspective view of the embodiment of FIG. 1.

FIG. 3 provides a front perspective view of an embodiment of two interconnected shelf support structures of the embodiment of FIG. 1 each with four shelf modules.

FIG. 4 provides a front perspective view of a second embodiment with four shelf modules visible.

FIG. 5 provides a rear perspective view of the embodiment of FIG. 4 showing a hotel cabinet and conveyor system.

FIG. 6 provides a rear perspective view of an embodiment of two interconnected shelf support structures of the embodiment of FIG. 4 each with four shelf modules.

FIG. 7 provides a perspective view of a first embodiment of a transfer device.

FIG. 8 provides a perspective view of a second embodiment of a transfer device.

FIG. 9 provides a perspective view of a third embodiment of a transfer device.

FIGS. 10A and 10B provide perspective views of embodiments of instrument shelf modules, FIG. 10A is a singular instrument shelf module, FIG. 10B is a multi-instrument shelf module.

FIG. 11 provides a perspective view of an embodiment of an pipetting shelf module.

FIG. 12 provides a perspective view of an embodiment of a conveyor shelf module.

FIG. 13 provides a perspective view of an embodiment of a stacker shelf module.

FIGS. 14A and 14B provide perspective views of embodiments of carousel-type storage shelf module.

FIG. 15 provides three views of an embodiment of a transfer facilitator, particularly a robot arm, useable on a shelf.

FIG. 16 provides an embodiment of a shelf support structure including additional panels enclosing the shelf support structure, and a service door.

FIG. 17 provides a perspective view of a shelf module in a position where it is slid from inside the embodiment of the shelf support structure of FIG. 17.

### DESCRIPTION OF PREFERRED EMBODIMENT(S)

Disclosed herein, among other things, are systems, methods and devices to handle and/or process products, preferably biological samples in sample plates, and/or other products in a controlled manner. Generally, the systems, methods and devices will be used to transfer physical objects such as, but not limited to, microtiter plates, petri dishes, sample plates, slides, tubes, or pipetting tips between a plurality of different mechanisms for manipulating them. One of ordinary skill in the art would understand, however, that the methods, systems and devices disclosed herein could be used in numerous settings outside those of a biological lab. For instance, an automated processing system (or vertical integration platform, or simply system, as it will generally be called herein) of the type disclosed herein may be used to manufacture, assemble, sort and/or store electronic components such as, but not limited to, computer chips or any other products. Alternatively, the automated processing system may be used to process or manufacture any products currently manufactured or processed in a horizontal manner.

An automated processing system of the current invention is generally designed to integrate laboratory instruments into an automated “plug and play” assembly line. It provides a means to move biological samples, reagents, chemicals, or other materials, resources, and/or products to and from mechanisms such as, but not limited to, instrumentation devices, processing devices, storage devices, transport devices or any other devices to which the object may be moved. In the vertical integration platform, the instruments are arranged with both a vertical and horizontal layout, or simply a vertical layout, to arrange any number of instruments for the transportation, storage, processing, manufacture, or control of the physical objects upon which the mechanisms in the system will operate within a limited footprint. For the purpose of this discussion, these physical objects will be presumed to be microtiter plates of the kinds well known in the art and including biological samples, but one of ordinary skill in the art would understand how the below disclosure can be adapted to allow for operation of the system to operate on other types of objects.

Further, automated processing systems of the present invention may have either vertical or horizontal layouts so long as the system includes the recognition and interfacing to allow the system to essentially be considered “plug and play.” However, it is generally preferred that the system have a generally vertical arrangement as it allows for space savings over a horizontal arrangement, and provides for a generally more modular shape. Because of this preference, the systems described herein will sometimes be referred to as vertical integration platforms which are generally considered to have a vertical layout. This represents merely exemplary embodiments of the invention which could alternatively have a horizontal layout.

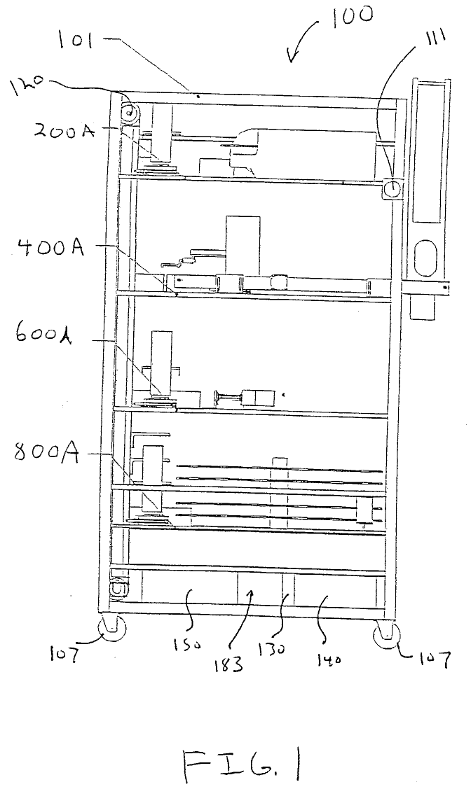

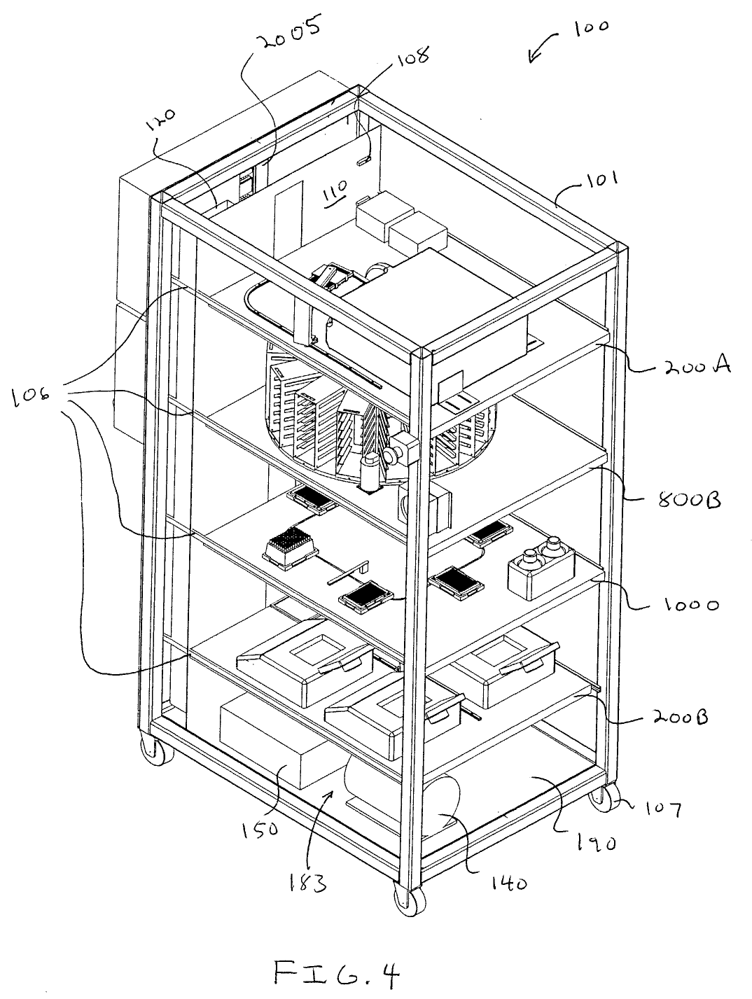

FIGS. 1-3 provide for a first embodiment of a vertical integration platform. FIGS. 4-6 provide for a second embodiment of a vertical integration platform. Generally, each of these embodiments has a similar structure but between the two embodiments some mechanisms and functionality have either been placed on different types of shelf modules and/or in permanent positioning. The two embodiments will generally be referred to interchangeably during this discussion as the discussion of the general components relates to both. When necessary, one or the other will be specifically referred to so as to illustrate an example.

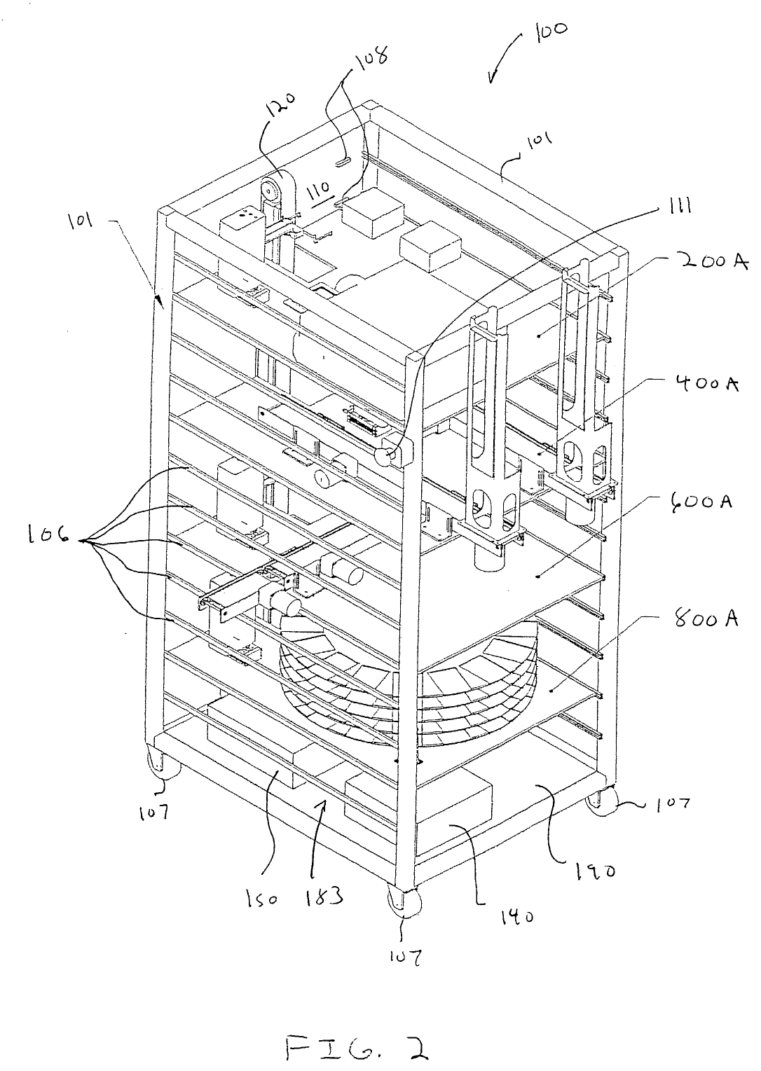

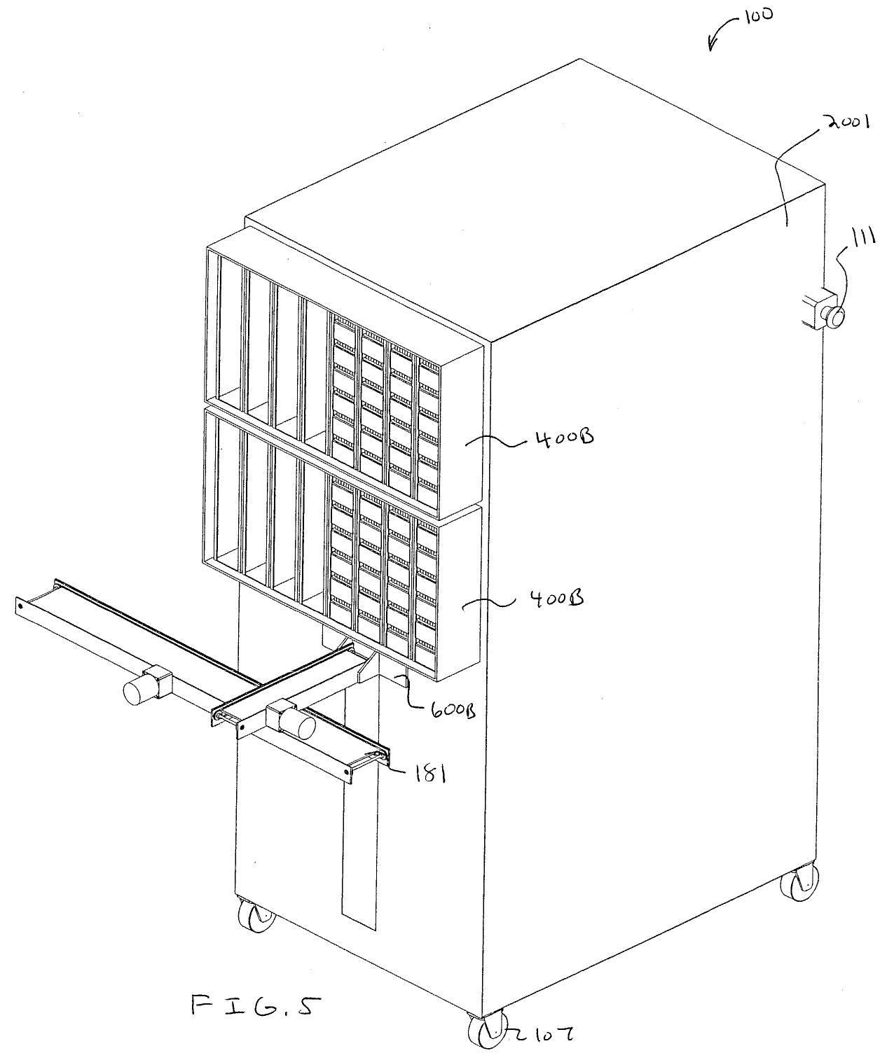

In the embodiments of FIGS. 1-6, each of the various mechanisms which are to become part of the automated processing system are mounted on objects called “shelves”. The instrument and shelf combination forms what is called a shelf module. The term “shelf” is used because the shelves often connect in a manner similar to shelves as known to those of ordinary skill in the art, however, that arrangement is by no means required. Instead, a shelf module is defined by functionality. When a shelf module is placed within a shelf support structure, the mechanism, processes, or purpose of that shelf module is automatically identified and can be utilized by other things in the shelf support structure. In FIGS. 1-2 there are four shelf modules (200A), (400A), (600A) and (800A) depicted. The embodiment of FIGS. 4-5 also includes four similar shelf modules (200A), (200B), (1000), and (800B) and two specialized shelf modules (400B) and (600B). Each of the shelf modules will be discussed in greater detail later in the disclosure. The shelf modules are positioned in a shelf support structure (100) as shown generally in FIGS. 1-6. The shelf support structure (100) may be of any shape designed to physically support the shelf and enable interconnection, as discussed later, but in the depicted embodiments, the shelf support structure (100) is generally a vertical tower. Most shelf modules are vertically arranged in the shelf support structure (100) so that each is held above other shelf modules, as opposed to side by side. This structure can provide for increased space savings and versatility.

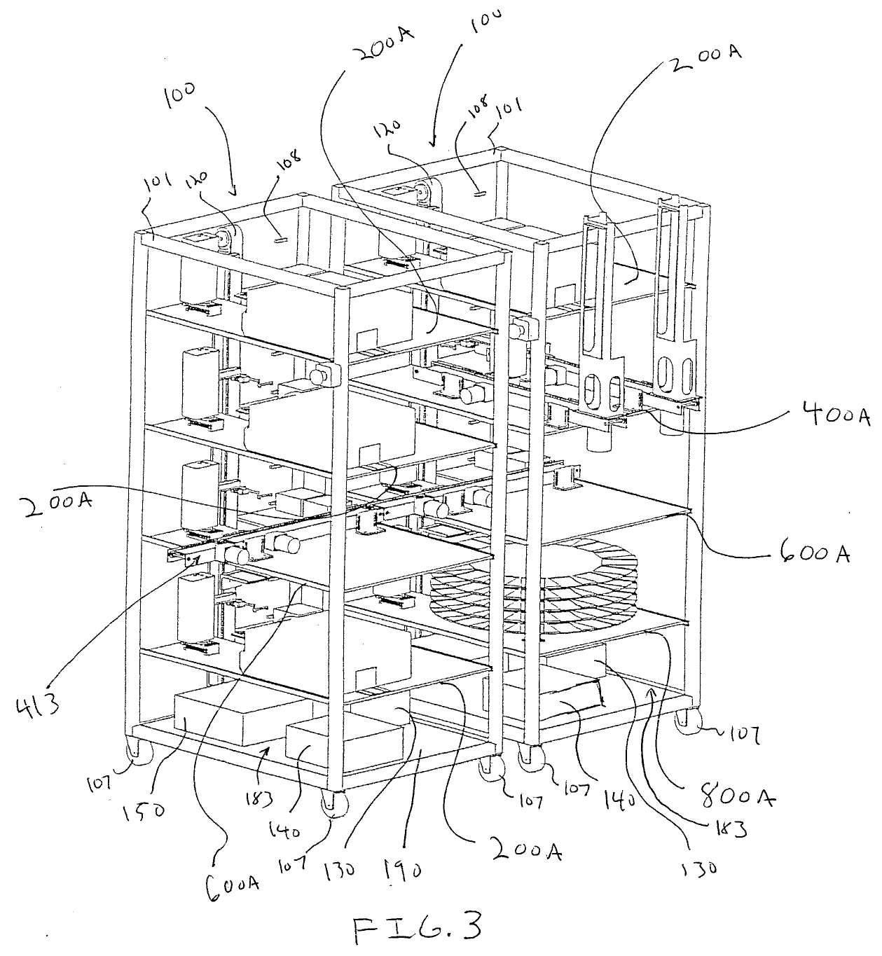

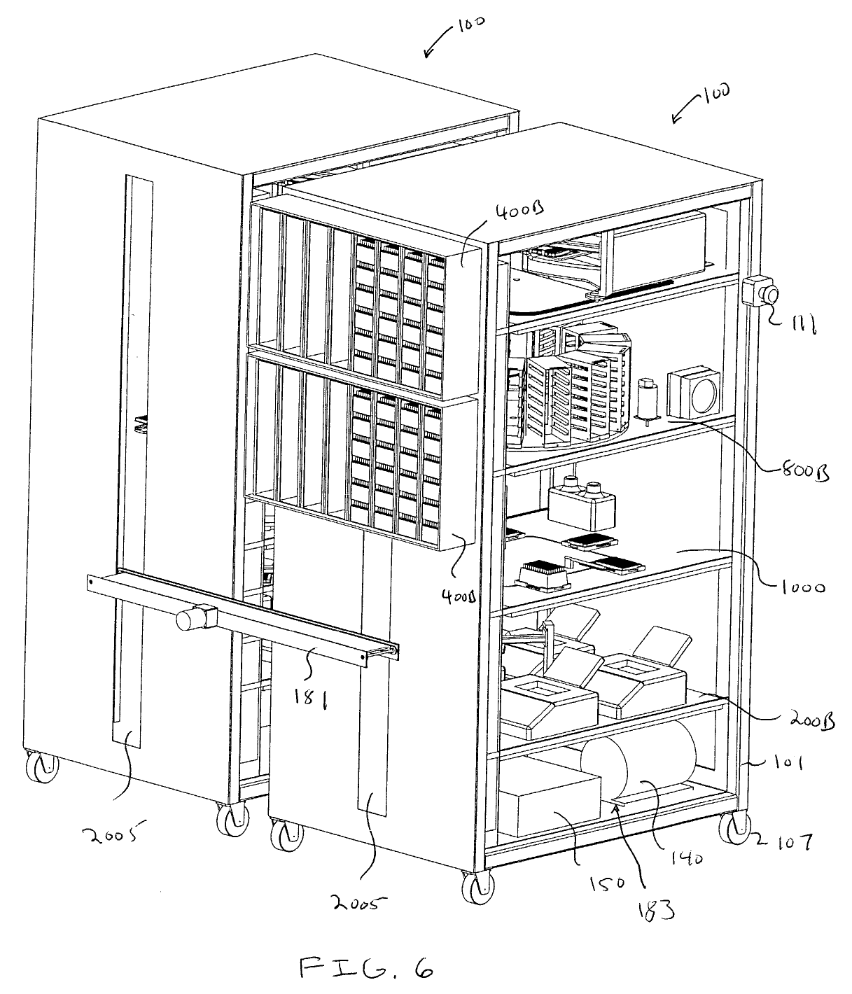

As shown in FIGS. 3 and 6, in an embodiment, multiple shelf support structures (100) may be connected together in a single automated processing system. In an embodiment, the physical objects could be passed between several shelf support structures (100) using specially designed shelf modules, as is discussed later, or by specifically designed conveyor systems associated with the shelf support structures (100). A shelf module comprising a conveyor shelf module (600A) (discussed later) is shown in the embodiment of FIG. 3. In the embodiment of FIG. 6, a fixed conveyor (181) is attached to support structure (100). In this embodiment, the transfer device (120) can access the conveyor (181) via an access hatch (2005) in the outer structure of the shelf support structure (100).

In the arrangement of FIGS. 3 and 6, each shelf support structure (100) can house various sets of mechanisms, could work independent of any other shelf support structure (100) and could pass objects back and forth to increase the overall system's throughput and functionality. With this methodology, the automated processing system can be considered infinitely expandable comprising one or more shelf support structures (100) with each shelf support structure (100) having any number of shelf modules. In another embodiment, specially designed shelf support structures (100) can also be used which do not utilize shelf modules, but are built to provide a particular set of unchanging tasks, or that are designed to house large or oddly shaped instruments that would not normally fit on a shelf module, but instead take an entire shelf support structure (100). In a still further embodiment, large or odd shaped devices may be connected into the network communication infrastructure but be mounted external to the shelf support structures (100) and provided objects by transfer device (120) or a conveyor.

The system including multiple shelf support structures (100) can be controlled either by selecting one or more of the shelf support structures (100) as a master unit which then controls a predetermined number of other units which are slaves, the shelf support structures could act as an interconnected network without a hierarchy, or the entire system could be controlled from a remote processor or processors (such as a personal computer or computers) to which it is associated. In still another embodiment, the system could form a part of a network (either wired or wireless), such as, but not limited to, an intranet, or the Internet and be controlled by other processors also attached to that network.

The user could also, through software, route the physical objects to be manipulated through different combinations of instruments depending upon their desired routine/experiment. Multiple users may use the system to run multiple disparate routines simultaneously. The shelf support structures (100) could form a general bank of instrumentation (instrument farm) that could be software configurable to provide virtually limitless possibilities for processing.

The general arrangement of an embodiment of a shelf support structure (100) is shown in FIGS. 1-6 and each shelf support structure (100) may be similarly configured. As shown in FIGS. 1-6, shelf support structure (100) generally comprises the main structure and control for shelf modules which are placed therein. In particular, it can be thought that the shelf support structure (100) provides the necessary infrastructure to which modular shelf modules can be freely added or removed, generally in a plug and play fashion. The primary component of shelf support structure (100) is frame (101) which provides the shelf support structure (100) with its general shape. Frame (101) will preferably be generally box-shaped and more preferably will have dimensional characteristics to fit through a typical 36″×84″ doorway without disassembly thus allowing improved mobility. As depicted in FIGS. 1-6, the frame (101) may be skeletal defining only a minimum needed to generate the resulting shape of shelf support structure (100), or alternatively may be more solid. Attached to frame (101) there may then be other components. In particular in FIGS. 1-6 there is depicted a fixed base shelf (190) (which in another embodiment may comprise a portion of frame (101) and/or may actually be removable like a shelf module) and a backplane panel(s) (110). Additional panels maybe added to enclose the shelf support structure (100) by placing such panels on the surfaces defined by frame (101). In FIGS. 1-3 no such panels are shown to provide a clearer indication of the internal arrangement of shelf support structure (100). FIGS. 5 and 6 shows some panels in place. In particular, side and rear panels.

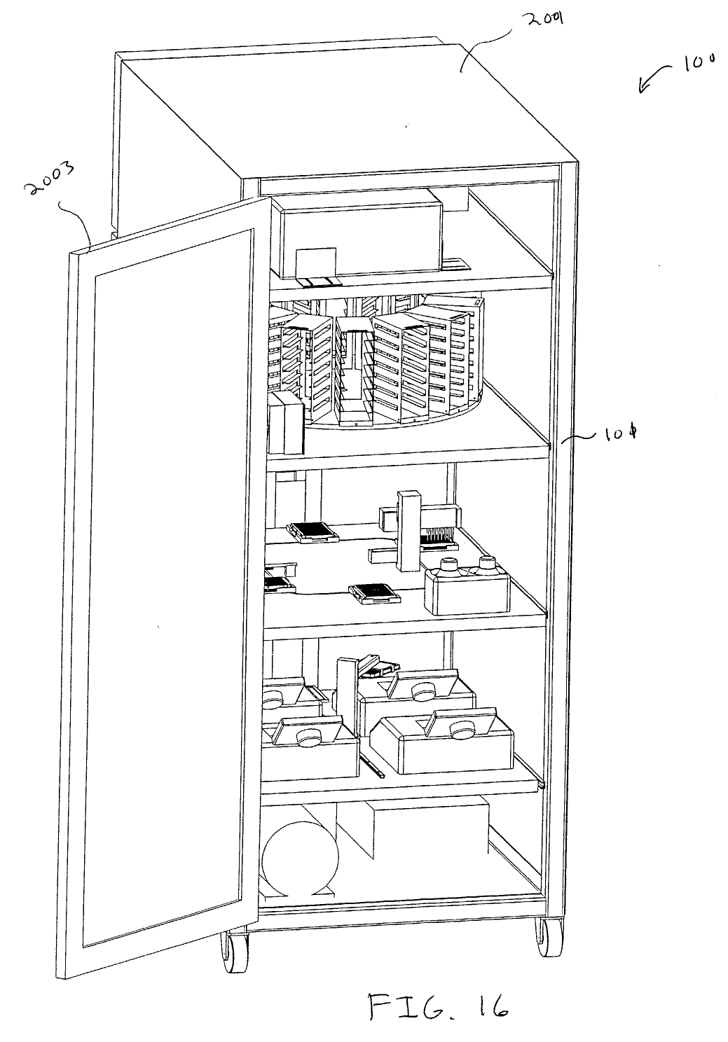

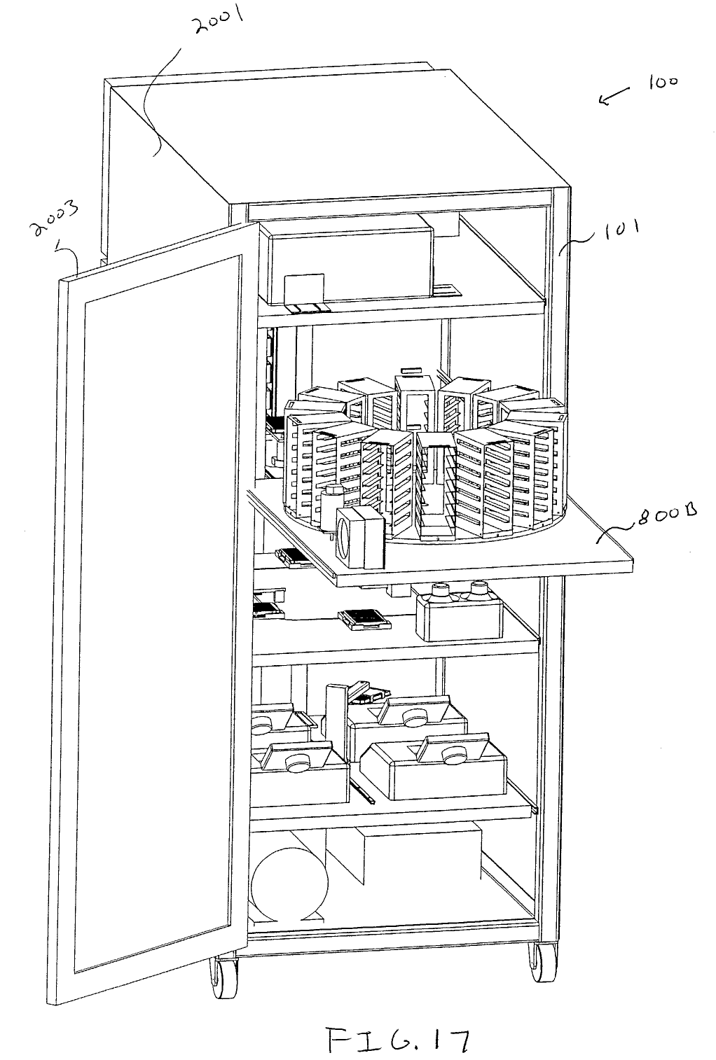

FIGS. 16 and 17, further show the inclusion of additional panels such as panel (2001). FIGS. 16 and 17 also provide a service door (2003) which allows for access of the interior of shelf support structure (100) from outside of shelf support structure (100) when the shelf support structure (100) is paneled. This service door (2003) may include a locking mechanism to hold the service door (2003) in either a shut and/or open position. Service door (2003), while depicted as hinged on the side, may open in any manner as is known to those of skill in the art including, but not limited to, hinging on any side or sliding. Further, in an embodiment, service door (2003) may be divided into any number of sub-doors,

FIGS. 5, 6, 16, and 17 also provide for an access hatch (2005). Access hatch (2005) may be used, as depicted, to allow for a conveyor (181) to extend from the enclosed area of the shelf support structure (100). Alternatively, access hatch (2005) may provide for a small access point for accessing the inside of the shelf support structure (100) for any reason without having to open service door (2003). While one long access hatch (2005) is depicted in FIGS. 5, 6, 17 and 18 shelf support structure (100) may include any number of access hatches (2005) in another embodiment. As shown in FIGS. 5 and 6 the access hatch (2005) may extended upwards in a generally vertical manner and may be sized and shaped so as to allow the transfer device (120) (discussed later) to reach through the access hatch (2005). Further, the panels (2001) may be able to be modularly removed. In particular, in the embodiment of FIG. 4, the upper half of the panel (2005) may have been removed so as to allow the hotel cabinet (400B) to be accessed from inside the shelf support structure (100) by the transfer device (120).

The panels and/or service door (2003) may be used to allow the interior atmosphere of shelf support structure (100) to be sealed from the atmosphere external to the shelf support structure (100). In this way, the internal atmosphere may be controlled to provide different environmental conditions to be maintained in the shelf support structure (100) and even for different environmental conditions to be obtained in different shelf support structures (100) in an interconnected arrangement (as shown in FIGS. 3 and 6 for instance). For example, one shelf support structure (100) may need to be refrigerated, another incubated, another hepa-filtered, or any other combination of conditions can be created within a system. The environmental controls (130) for controlling the internal environment are discussed later.

Shelf support structure (100) may include a safety interlock to insure sealing of the shelf support structure (100) and or provide for emergency shutoff of the shelf support structure if necessary. The shelf support structure (100) may also include pipes, hoses, wires or similar structures so that various resources can be provided from external sources to the shelf support structure (100). Further the frame (101) is generally mounted on wheels (107) (such as, but not limited to casters) or other instruments to facilitate movement of the shelf support structure (100) in the generally upright position depicted in the FIGS.

Attached inside the area generally enclosed by the frame (101) are drawer guides (106). Drawer guides (106) will generally be attached to provide for a shelf module to be attached horizontally to two opposing sides of frame (101). A shelf module will generally connect in a mating relationship with the drawer guides (106) so as to slide into and out of the area of the shelf support structure (100) to allow for easy access to the instruments on the shelf module, even when the shelf support structure (100) is partially enclosed.

FIG. 17 shows how a shelf module can slide on drawer guides (106). Drawer guides (106) will generally be spaced at equal intervals in the vertical direction and correspond on opposing sides of the frame (101). In the example depicted in FIGS. 1-3 there are twelve such drawer guides (106) on either side of the shelf support structure, In FIGS. 4-6 there are only 4 sets. In an embodiment, drawer guides (106) are spaced on a 6-inch pitch spacing in the vertical direction. To form drawer guides (106), commercially available drawer guides maybe utilized, custom drawer guides may be used, and/or alternative guide systems using roller bearings, guided tracks, and/or other systems may be used. Drawer guides (106) are used to allow the insertion and alignment of shelf modules such as shelf modules (200A), (200B), (400A), (600A), (800A) and (800B). Drawer guides (106) can also allow an operator to slide a shelf module out to an extended position for cleaning, servicing, or loading/unloading as shown in FIG. 17. Shelf modules may also be easily removed, inserted, or relocated within the system in an embodiment by disconnecting the shelf module from the drawer guides (106). Some form of alignment device such as dowel pins may be used to precisely align the shelf module position within the shelf support structure (100) when shelf modules are inserted and in another embodiment the drawer guides (106) may be moveable internally within the shelf support structure (100) to assume different positions. A locking mechanism may also be used to secure shelf modules during operation of the vertical integration platform or movement of the shelf support structure (100).

In the depicted embodiment, a fixed base shelf (190) is attached to the frame (101) near the bottom of the shelf support structure (100) or at another convenient location. Base shelf (190) may essentially be a bottom panel and may be used to mount various products which are used to control the shelf modules within the shelf support structure (100), or to control features of the shelf support structure (100) itself. These devices generally form the central control system (183) of the shelf support structure (100). The exact devices used in the central control system (100) may vary, but the central control system (183) will provide for the “over-all control” of shelf modules placed in the shelf support structure (100). The central control system (183) may also supply a universal feed of resources or additional functionality in addition to this control. While the depicted embodiment places the central control system (183) on a fixed base shelf (190), that is by no means required and the central control system (183) may be located anywhere either within the frame (101), on a shelf, or externally but in communication with the shelf support structure (100).

In the depicted embodiment, the central control system (183) comprises three separable units, environmental controls (130), electronic and utility enclosure (140), and host computer (150). Further, the base shelf (190) may include communications devices for communication between those components, with shelf modules, or to other components external to the shelf support structure (100).

Environmental controls (130) may be used to control the environment of the entire shelf support structure (100), shelf modules, subassemblies, or any combination of these components contained in the system. Such environmental controls may include, but are not limited to, humidification, dehumidification, temperature control, air filtration, UV or gaseous sterilization, pressurization, air re-circulation, gaseous controls, or air exhaust such as to a fume hood. It may also contain safety interlock circuitry to prevent hazards to the operator during certain internal environmental conditions. It may comprise environmental sensing circuitry, environmental control circuitry, refrigeration devices, water chilling devices, water heating devices, heat exchangers, or any other type of device which may control and/or monitor the environmental conditions within the shelf support structure (100). Further, there may be machinery or transport devices associated with environmental controls to create the desired environment, and/or to transport ingredients of the desired environment to a particular part of shelf support structure (100) and/or a particular shelf module. In an embodiment, the environmental controls (130) may have access to external resources such as gas tanks, air filtration systems, liquid sources or faucets, and/or other similar resources through hoses, pipes, wires, chambers or other transportation devices attached to environmental controls (130) and/or shelf support structure (100).

The electronic and utility enclosure (140) will generally include electric and other resources for distribution to various shelf modules within the shelf support structure. It may therefore contain, amongst other things, electrical disconnects to protect internal wiring, auxiliary instrumentation/devices, and external instrumentation/devices from electrical circuit failures. These are likely to be circuit breakers, fuses, resettable fuses, or similar disconnects. Another component may be a direct current power supply. This will supply power to shelf modules or external devices requiring DC power. Such power will likely be in the form of +5VDC, +12VDC, and +24VDC although other voltages may be used as would be understood by one of ordinary skill in the art. Electrical power distribution will generally originate from enclosure (140) (which may internally generate the electrical power or may obtain it from an external source such as through the use of a plug to connect with a wall mount or similar socket) and distribute AC and/or DC electrical power to connection plugs (108). An uninterruptible power supply may be included to prevent the loss of data and system stability during a brief utility power failure or utility power voltage drop. Surge suppression may be used to eliminate the loss of data or equipment damage resulting from high voltage spikes received by electrical and communication system (140), and signal conditioning may be used to eliminate electrical noise on the main incoming power circuit, if appropriate. Safety circuitry may also be used to protect the instruments and operators from harm. This could include emergency stop circuitry activated in the event that the emergency stop switch (111) is depressed. It may also include door ajar safety interlock circuitry, over-temperature shutdown circuitry, pressure level circuitry or similar. Pneumatic or hydraulic regulation, filtering and conditioning may also be included. Generally, there will also be some form of transport to allow for pneumatic, electrical, or other distribution to connection plugs (108). A pneumatic dump valve may also be included to relieve air pressure to the system in the event that the emergency stop switch (111) is depressed. Further, the electronic and utility enclosure may have control of locking mechanisms for access door (2003) to provide that the door is locked when the system is operating, and may further have access to an airlock or similar structure to allow for emergency venting of the internal atmosphere, if required.

Generally, both the environmental controls (130) and the electrical and communication system (140) will provide what are broadly termed “resources.” These are things made available to the shelf modules which the mechanisms thereon may need to perform their tasks. Generally, the electrical and communication system (140) will provide resources used in operation of a particular shelf module, whereas environmental controls (130) will provide resources for controlling the environment in which shelf module(s) operate, but this is by no means required.

Host computer (150) is generally comprised of a computer or other processor, communications to external computer networks, communications to devices external to the system, internal communications distribution, a software operating system, and/or control software. The host computer (150) itself will often be a small desktop PC configured for inclusion in the shelf support structure (100) but may also be a dedicated processor or processing system. Communications to external computer networks may utilize a high speed Ethernet protocol although any protocol known to those of ordinary skill in the art may be used. Communications to external devices may also comprise Ethernet protocol or serial communications although, again, any protocol may be used as would be understood by those of ordinary skill in the art.

Communications distribution within shelf support structure (100) will likely be comprised of an Ethernet connection originating at the host computer (150) and extending through a network communication interface arranged in the shelf support structure (100). A multiport Ethernet hub will likely be used to make Ethernet connectivity from the host computer to each of the connection plugs (108) thereby having the connection plugs (108), in conjunction with the host computer (150) form the network communication infrastructure. As shelf modules are inserted into the system, the local processor (270) contained on the shelf module will preferably automatically connect to the network communication infrastructure using standard Ethernet protocols by mating connection plug (280) on the shelf module being plugged in or otherwise connected to the connection plug (108) corresponding to the particular drawer rails (106) on which the shelf module is placed. In an alternative embodiment, wireless protocols may be used with shelf modules being identified by proximity transmissions or similar. The connection between the shelf support structure (100) and the shelf modules is discussed in greater detail in conjunction with the discussion of the various shelf modules.

Connection plug (108) may be attached to the backplane panel (110) or otherwise supported within the frame (101). Connection plugs (108) will typically be equally spaced in the vertical direction in the same spacing pitch as the drawer guides (106) and arranged such that a shelf module placed in drawer guides (106) and pushed or retracted into shelf support structure (100) will engage the appropriate connection plug (108) with a mating connection plug (280) on the shelf module. As depicted in FIGS. 1-3, there could be twelve such back plane connectors (108) equally spaced vertically on a 6-inch pitch. This allows connectivity to shelf modules at the insertable locations defined by the twelve sets of drawer guides (106). Generally, when a shelf module (such as instrument module (200A)) is inserted into the shelf support structure (100), it is placed so as to run on drawer guides (106). The shelf module will then be pushed back into the shelf support structure (100). When the shelf module reaches the back of the shelf support structure (100), the connection plug (108) associated with the particular set of drawer guides (106) onto which the shelf module was placed, will interconnect with the mating connection plug (280) on the shelf module. This will generally electrically (and/or pneumatically or otherwise) connect the shelf module to the shelf support structure (100). The interconnection of connection plug (108) and mating connection plug (280) will also allow the central control system (particularly host computer (150)) to communicate with the shelf module via the network communication infrastructure and for electrical and communication system (140), and/or the environmental controls (130) to provide any resource or control which may be needed by a particular shelf module, to that shelf module. In another embodiment, connections other than the above could also, or alternatively, be used.

Connection plugs (108) may therefore allow communication connections with the shelf modules and connect the shelf modules to any necessary resources. Such resources could include, but are not limited to, DC electrical power, AC electrical power, pneumatic supply, chilled or heated water, vacuum suction, steam, air, gas supplies, or any other resource. Safety circuitry signals may also be interfaced through these connectors such as to insure that a shelf module is correctly attached. In addition, the connection plugs (108) may have a method to contain digital data identifying the unique shelf location within the system. In this manner, the shelf module could determine it's specific location within the system and pass this information to the central control system. This digital address could possibly be through utilizing the Ethernet IP address.

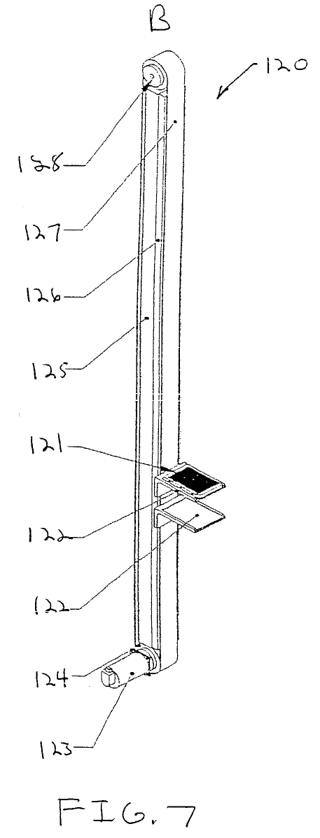

A transfer device (120) will preferably be utilized to transport physical objects the system is to process between the shelf modules. A more detailed drawing of three embodiments of transfer mechanisms (120) is provided in FIGS. 7-9. All of these transfer mechanisms are in a subcategory referred to as vertical lift mechanisms. These are designed with vertical motion being the principle movement to allow interaction with different shelf modules. Transfer devices (120), however, include various different degrees of flexibility and functionality.

In the embodiments of FIGS. 7-9 the transfer device (120) includes an electrically powered motor (123) such as, but not limited to, a stepper motor or a servomotor to power transport portions (122) of the device (120) up or down vertically. The motor (123) will likely utilize closed loop feedback for precise control, but that is not necessary. Software control of the functions and movement of the lift mechanism (120) will generally be handled by the host computer (150) and associated structure. Mechanical drive mechanisms connecting the motor (123) and the transport portions (122) may include, but are not limited to, belts and pulleys, ball screw, lead screw, rack and pinion, or other mechanical systems. Linear guidance for determination of the vertical position of any particular transport portion (122) may be accomplished utilizing belt tension, belt guide, linear rail and bearing, a set of vertical guide rods with concentric bearings, or any other method known to those of ordinary skill in the art.

The embodiment depicted in FIG. 7 utilizes a simple endless belt and pulley system as vertical lift mechanism (120). The motor (123) turns the drive pulley (124). The drive pulley (124) is engaged with the belt (127), which has transport portions (122) (which are simple fixed platforms) affixed thereto. The belt (127) is tensioned by the idler pulley (128) and is guided using the belt guide track (126). The entire assembly is affixed to structure support member (125) for rigidity and mounting. As the drive pulley (124) rotates, the belt (127) transfers the rotary motion into linear motion, thereby moving transport portions (122) up and down. The object to be transported (which is generally the product to be processed, but need not be) is the payload carried on the platform of the transport portion (122).

In another embodiment, there could be included multiple transfer devices (120) in a single shelf support structure (100) instead of just one as shown in FIGS. 1-6. In such an arrangement, each transfer devices (120) could have a dedicated path or motion not related to the motion of the other transfer devices (120). Alternatively, the transfer devices (120) could operate under a single control providing a particular efficiency program. For instance, if an object needed to be moved from one shelf module to another, the transfer devices (120) which can perform the task the quickest could be tasked with so moving the object.

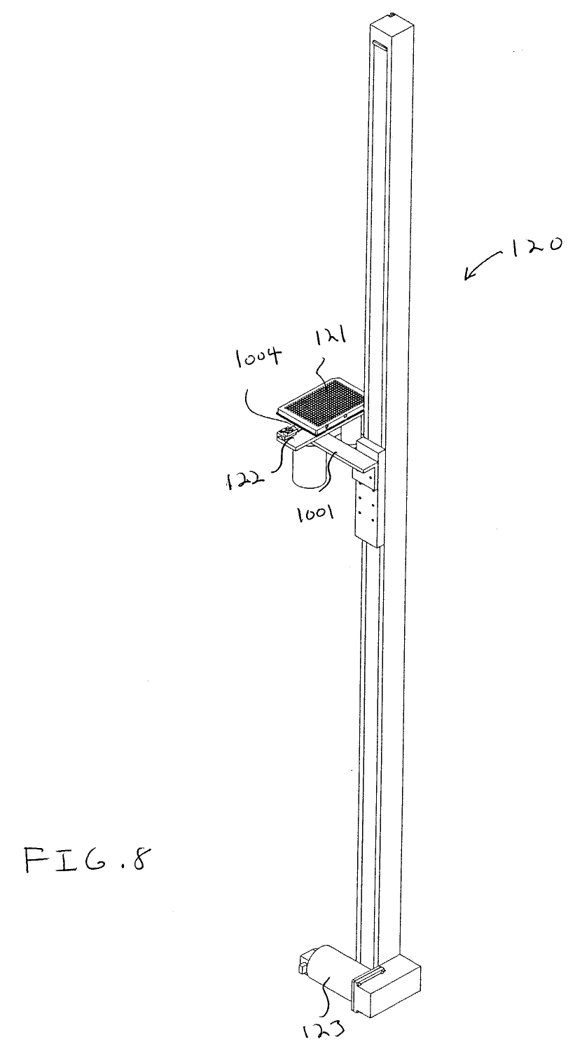

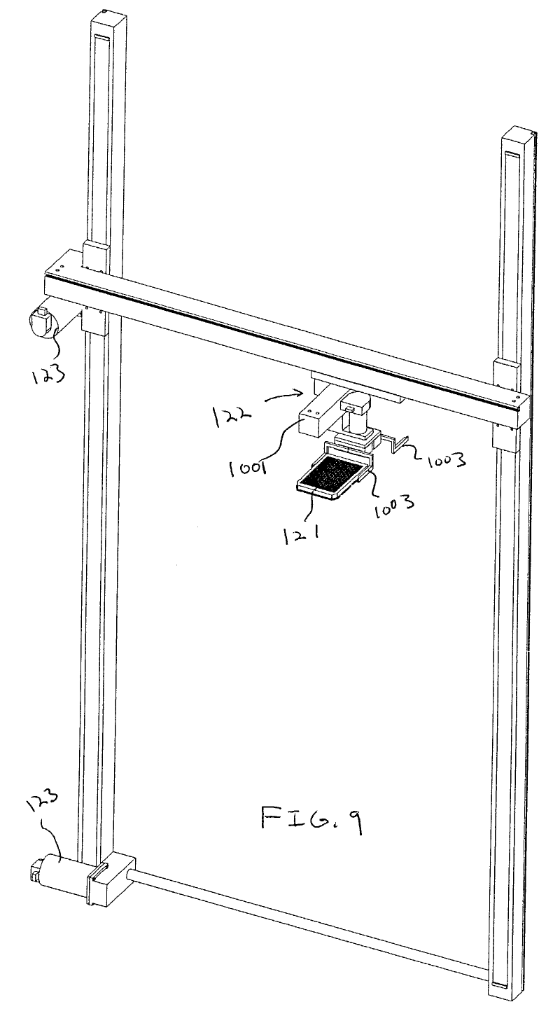

In still another embodiment, the transfer devices (120) comprises a robotic arm which can traverse various tracks to provide different degrees of motion. Two such embodiments are shown in FIGS. 8 and 9. In particular, the transport portion (122) could include or be replaced by a gripper or other structure which instead of passively supporting the load, could actively grip the load to transport it as shown in FIG. 9. Alternatively, the transport portion (122) could be replaced by a moving “spatula” system where the transport portion (122) can adjust to slide under and pickup an object (essentially a moving platform) as shown in FIG. 8.

As shown in FIGS. 8 and 9, the lift could include an articulated arm (1001) that moves vertically (such as by hydraulic or pneumatic pressure control) carrying samples between shelf modules such as in a set of grippers (1003) or on the spatula (1004). This arm (1001) could reach in and place or remove samples onto and off of the shelf modules. One arm (1001) could traverse the complete set of shelf modules or in an alternative embodiment, multiple arms could be used. Arm (1001) could also reach outside of the shelf support structure (100) to place products on external equipment not included inside the shelf support structure (100), or could place a product into a neighboring shelf support structure (100) if the shelf support structures (100) are in an arrangement such as that of FIG. 3 or 6. Arm (1001) could also remove lids from the products and place them on a rest or on a specially designed lid storage shelf module. The coordinates to guide the arm (1001) to the correct locations on each shelf module could be stored in the local processor (270) of the particular shelf module. Configurations for such an arrangement could be carried out while the shelf module is not physically connected to the system using a jig allowing arm coordinate data to be transferred to the local processor (270). When the shelf module is loaded into the shelf support structure (100), the coordinate data may then become available to the central control system (183). In an embodiment the arm (1001) may therefore replace or render duplicative the transfer facilitator (220) located on the shelf module.

In the embodiment of FIG. 9, there is a fully three dimensional robot arm as the transfer device (120). In this picture, the robot arm can rotate, and move in any of three different dimensions. The robot arm also includes two sets of grippers. In this way, the robot arm may transport two objects at once, or may grab one object, rotate and drop another therefore minimizing robotic moves. In this embodiment the robot arm can have access to any shelf module as well as to place objects in hotel cabinet (400B) or on the external conveyor (181) which are located behind the shelf support structure (100).

One of ordinary skill in the art would understand that the discussion of the transfer mechanisms herein has provided only a few embodiments of transfer mechanisms which can be used in the automated processing systems of the present invention. The transfer devices (120) can range from simple to complex but allow for the physical objects to be manipulated to be carried between the shelves. Further, the transfer device (120) will generally be under the control of the central control system (183) which will direct the transfer device (120) on how to transfer the physical objects.

The design of the shelf support structure (100) of FIGS. 1-6 uses shelf modules to provide for the various operations to be performed in the shelf support structure (100). The use of removable shelf modules provides for numerous benefits. In particular, machine maintenance will be simplified as shelf modules can be removed for repair/reconfiguration without the whole system being rendered inoperable, particularly if the functionality remains on another shelf module within the system. Further, configuration of shelf modules can be carried out off-line and separately from the shelf support structure (100) and may be performed under specific controlled conditions without having to place shelf support structure (100) in those conditions. When the shelf module is inserted into the shelf support structure (100), it is preferable that it be recognized by the central control system (183) and made available for processing of product. In particular, it is desirable that when the shelf module is connected, the central control system (183) is provided with information, via the network communication infrastructure, to recognize the functionalities of the shelf module and to know how to place products onto and/or off of the shelf module. This may be either by recognizing the mechanism(s) present on the shelf module, recognizing a functionality of the shelf module, or recognizing the shelf module itself. Generally, recognizing the mechanism will be used as exemplary throughout this disclosure as all identification methods eventually recognize the mechanism.

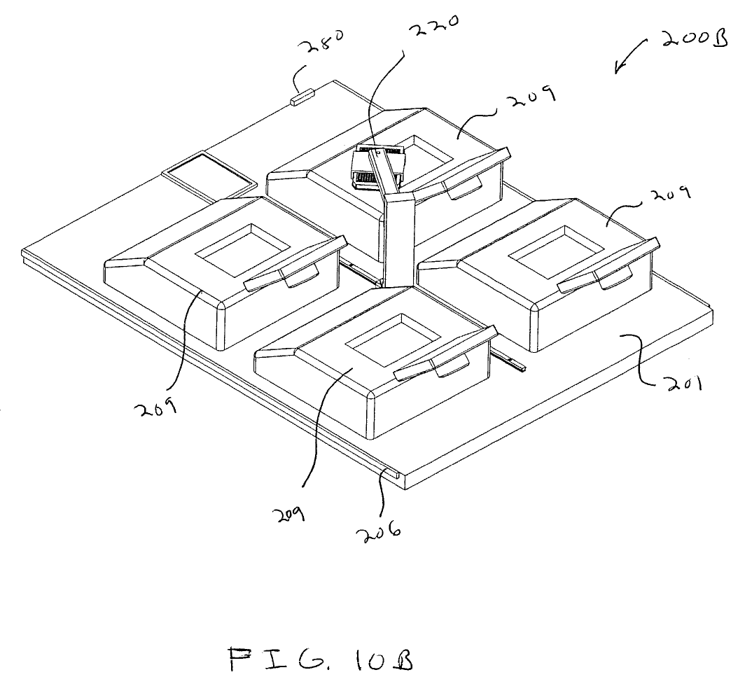

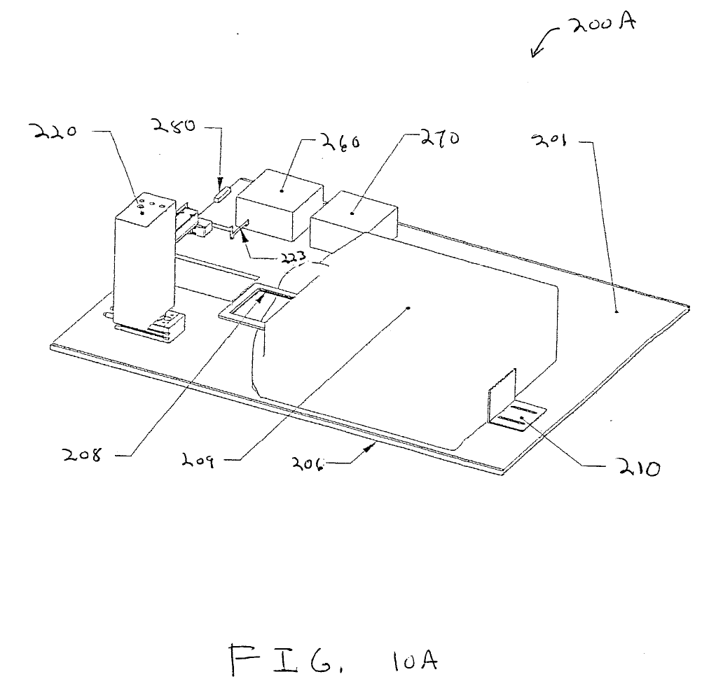

In FIGS. 10-15 there are shown seven exemplary shelf modules of five different types. Further, FIGS. 4 and 6 show embodiments of specialized shelf modules. One of ordinary skill in the art would understand that a shelf module could have a virtually limitless functionality depending on the mechanism(s) placed thereon, so the described embodiments of shelf modules should not be used to limit this disclosure in any way. For the purposes of this disclosure, each shelf module will be referred to as having at least one mechanism thereon, a mechanism may be any object which is designed to interact with the physical object provided by the transfer device (120) to the shelf module, in any way.

Mechanisms include, but are not limited to, robot arms, commercial instrumentation modules, storage devices, mechanical drives or specially designed components. These mechanisms may move, turn, lift, rotate, or otherwise manipulate the physical object, or may interact with the object or the contents of the object such as by adding substances thereto, determining a property of the substance, or otherwise manipulating or observing the contents. For the purposes of this disclosure, the shelf modules discussed will presume that the physical objects provided are microtiter plates including biological samples. The mechanisms will move the microtiter plates, add things to the samples, store the microtiter plates, and/or analyze or measure something with regards to the samples, depending on the particular embodiment of the shelf module.

The first exemplary shelf modules are instrumentation shelf modules (200A) and (200B) shown in FIGS. 10A and 10B. Instrumentation shelf modules (200A) and (200B) generally provide a means to transport a sample or product to and from benchtop size instruments that would normally be used in the processing of the object and that fit within the shelf support structure space limitations. The embodiment of FIG. 10A is designed for an instrument of roughly the same footprint as the size of the shelf module. FIG. 10B is designed to hold multiple smaller instruments. Instrumentation shelf modules (200A) and (200B) also can allow for local control and provision of resources to these instruments if such local control and or resources are desired and/or necessary. Local resources will generally be resources that are required by a particular instrument, but are not required often enough to justify their inclusion in the resources provided by the shelf support structure (100) so they are included on-board instrumentation shelf modules (200A) and/or (200B).

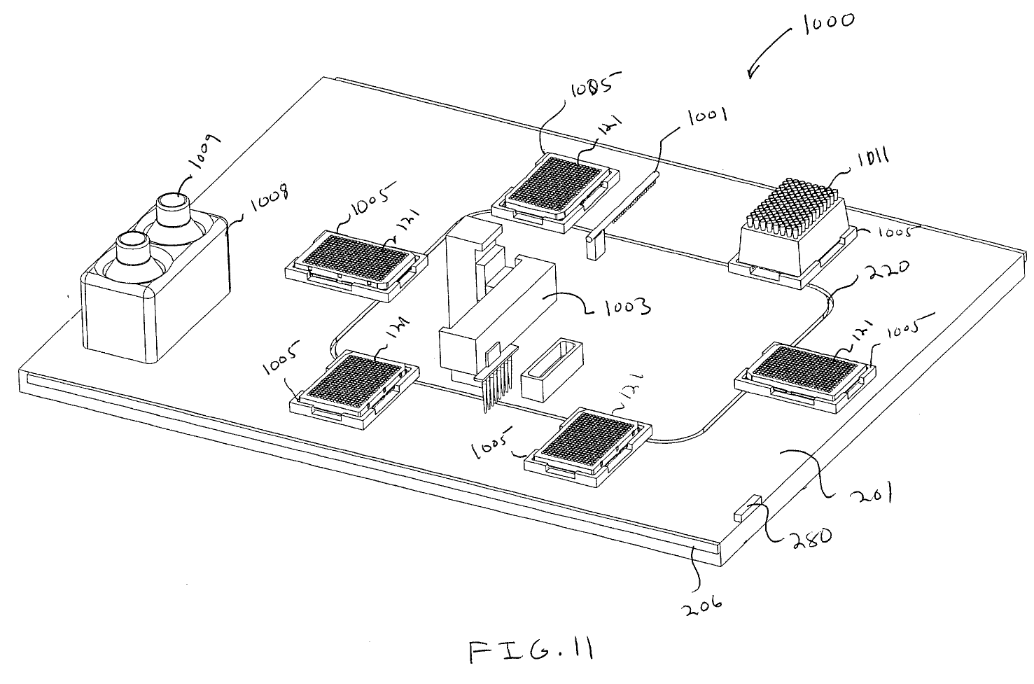

An embodiment of an pipetting shelf module (1000) is depicted in FIG. 11 and is generally utilized to provide for a series of stations within an individual shelf module, as well as some form of conveyor system to progress the physical objects through the stations. In the depicted embodiment of FIG. 11, pipetting stations are shown to provide for a general pipetting operation.

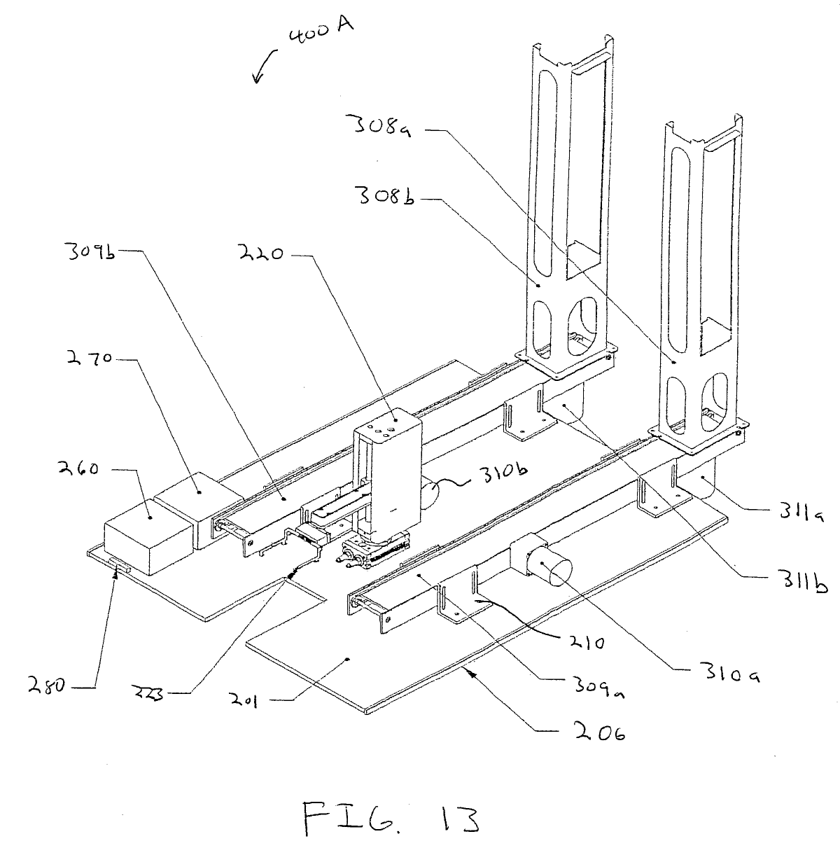

An embodiment of a stacker shelf module (400A) is depicted in FIG. 13 and is generally utilized to get products to be processed into and out of the system using storage racks (308a) and/or (308b). Alternatively, specific resources (such as disposable pipette tips) could be loaded into stacks to be provided to a particular shelf module which required those resources, or to remove used, damaged, or expended resources from the shelf support structure (100). A stacker shelf module (400A) may be used instead of or in addition to a hotel cabinet (400B) which has much the same functionality but is mounted differently. However, the stacker shelf module (400A) may be preferable to load a large quantity of items into the system, if the hotel cabinet (400B) is already in use for storing samples (physical objects).

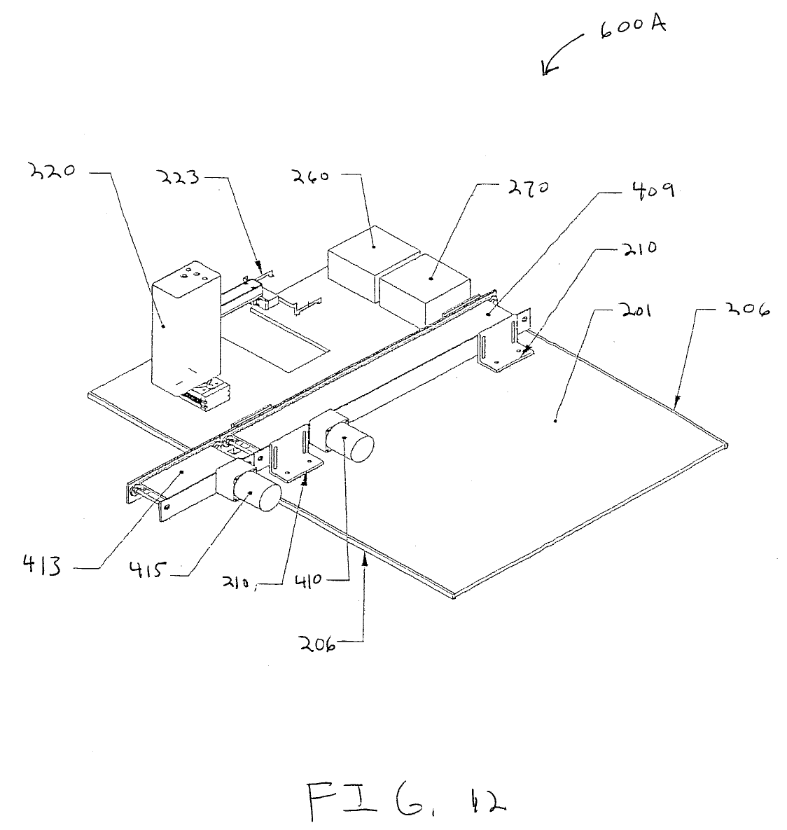

An embodiment of a conveyor shelf module (600A) is depicted in FIG. 12. This module is generally utilized to get products into and out of external instruments/devices and or other shelf support structures (100) and is conceptually similar to stacker shelf module (400A). Further, the conveyor shelf module (600A) may be provided in addition to or instead of a fixed conveyor system mounted to the shelf storage structure.

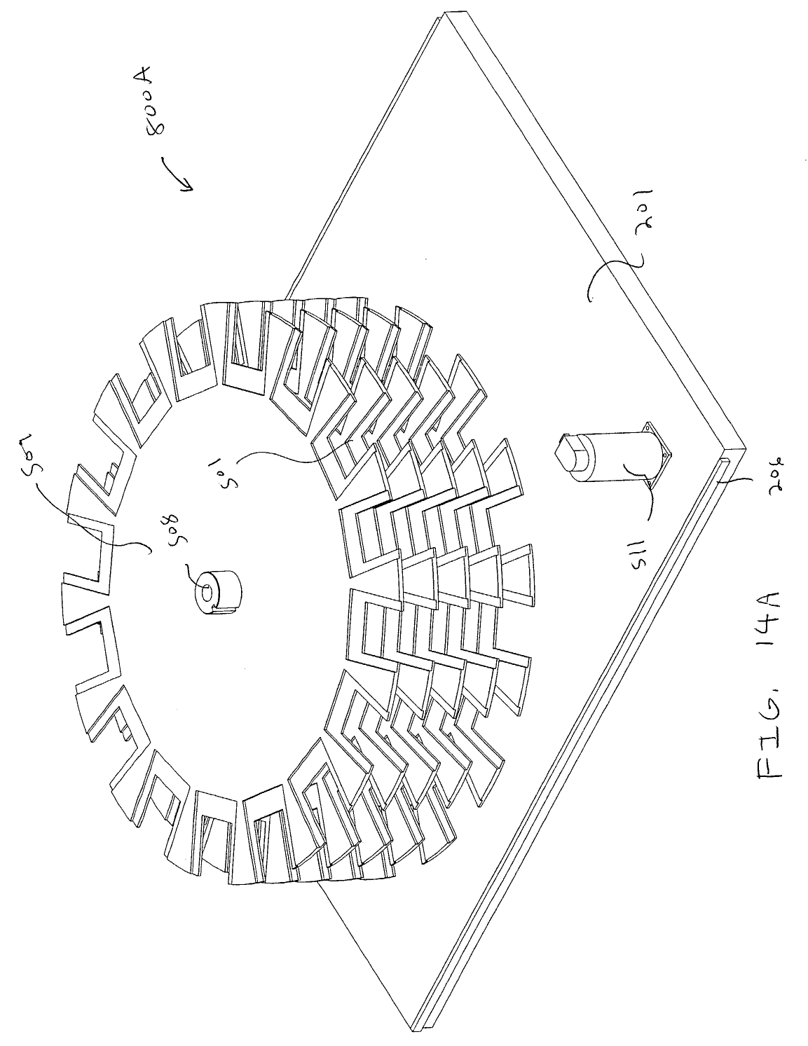

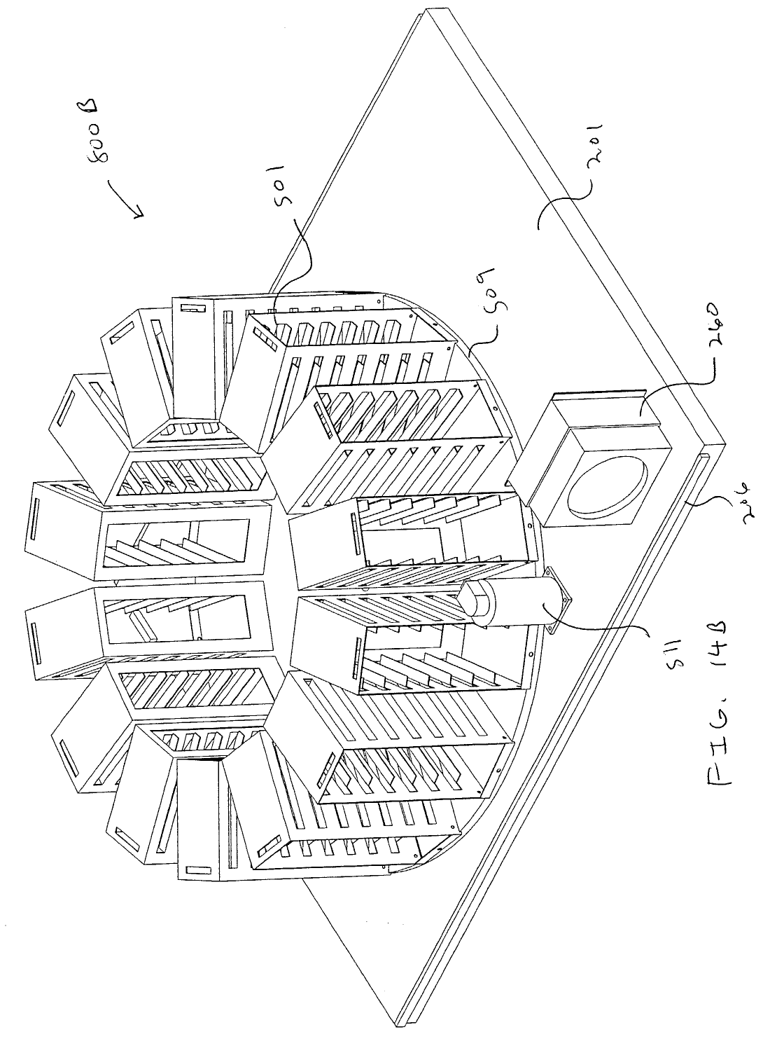

Carousel-type storage shelf modules (800A) and (800B) are depicted in FIGS. 14A and 14B. A storage shelf module (800A) or (800B) is generally utilized to store products in the shelf support structure (100). This storage may be optionally environmentally controlled as a unit. Such an embodiment would allow for the shelf to include walls, panels, or other similar structures so that the carousel and objects therein are stored under certain conditions, even if those conditions are not maintained in the rest of the cabinet. For example, the contents of the shelf may be incubated or refrigerated. This could allow for a shelf module comprising an incubatory refrigerator, or similar environmental shelf module.

Regardless of the type of shelf module used, the drawer rail mounted shelf modules share some general structure to allow for placement in shelf support structure (100). In particular, the main structure of the shelf module is the shelf plate (201). Affixed to the opposing side edges of shelf plate (201) are shelf guides (206). The shelf guides (206) are designed to matingly engage to the drawer guides (106) affixed to the frame (101). This allows the shelf module assembly to slide in or out of the shelf support structure (100) as previously discussed. Further, the shelf guides (206) and drawer guides (106) are preferably designed so that a shelf module, when pulled out of shelf support structure (100) can be removed completely from shelf support structure (100), if desired.

The shelf plate (201) will preferably be machined with a matrix of tapped holes, although in another embodiment may be solid. The use of holes will accommodate the mounting of components to its top surface in a modularly and completely interchangeable fashion. Generally, the mechanism(s) to be held will be attached by adjustable clamping angle brackets (210) to secure location and allow for minor lateral adjustments. The clamping angle brackets (210) are generally bolted or otherwise attached to shelf plate (201) using the tapped holes. In still another embodiment, shelf plate (201) need not be planar, but could include indentations or other shapes to provide for mounting of the various components thereon into recesses or similar structures.

There may be included on a shelf module a transfer facilitator (220) which will be used to transport the physical objects on the shelf such as by taking them from a predetermined “staging area” on the shelf module to a predetermined location on the shelf module. Although the embodiments of shelf modules depicted in FIGS. 10-14 usually provide a “robot arm” as part of the shelf module, other transfer facilitators may be used. These other mechanisms may include, but are not limited to, conveyors, assemblies of pneumatic cylinders, hydraulic cylinders, electric actuators, electromagnetic systems or other components or a hybrid design of various components. In other embodiments, or even on different shelves, the transfer facilitator (220) may be eliminated as unnecessary because the transport portion (122) of the transfer device (120) may have sufficient flexibility to be able to interact directly with the mechanisms on-board the shelf module. In the depicted shelf modules, some will utilize internal transfer facilitator (220), while others allow for direct access by the transport portion (122) of the transfer device (120).

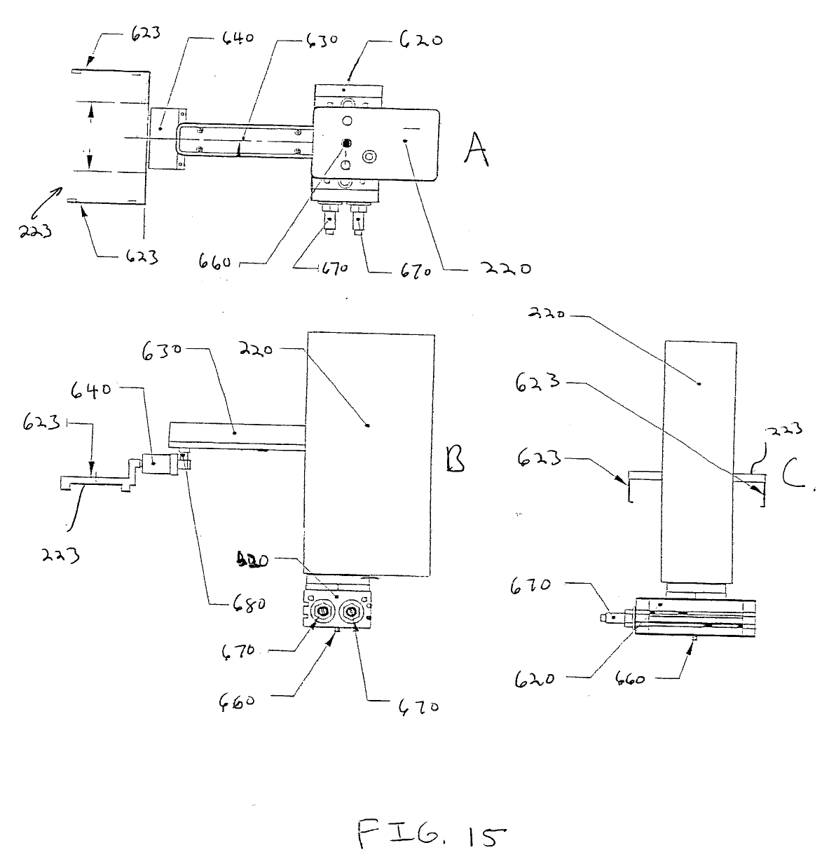

The particular positioning of transfer facilitator (220) on the shelf plate (201) is also only one of many possibilities. The position and orientation that the transfer facilitator (220) is affixed to the shelf plate (201) will generally be dictated by the dimensions and arrangement of the other mechanisms on the shelf module, the position and orientation of their associated product portals (208), the position that the transfer device (120) will present the product, and/or the type of transfer facilitator (220) used. An embodiment of a transfer facilitator (220) is depicted in FIG. 15. In an embodiment, lid removal for products (such as microtiter plates) could be accomplished with the transfer facilitator (220), a lid removal shelf module may be utilized, or a special lid mechanism removal instrument could be included with the appropriate shelf module.

As discussed previously, the transfer device (120) may place the product on the appropriate shelf module in a “staging area” (or in multiple different staging areas, depending on the embodiment) or could push the product from a platform (122) onto a shelf module at a particular point. Transfer facilitator (220) or similar structure could then grasp the product from the staging area(s). Such an arrangement could prevent the transfer facilitator (220) from passing within the area traversed by the transfer device (120). In addition, the inclusion of a staging area could provide for a particular shelf module to have a queue of products to be operated upon which may increase efficiency and/or throughput of the shelf support structure (100). A staging area can also allow for a universal connection point to a particular shelf. In particular, with regards to instrumentation shelf (200), a staging area can allow the placement of the object at a universal location for the processing regardless of the mechanisms on board the shelf. In this way, each shelf module can be individually calibrated for the particular mechanism(s) placed thereon, without having to provide any such calibration to the central control system (183). Alternatively, the staging area could actually be a component of a transfer facilitator (220) onboard the particular shelf module, allowing for immediate moving of the physical object once placed on the shelf. This type of structure is shown in the shelf module embodiment of FIG. 11.

Control for the local functions of the shelf module, including the instruments placed thereon and any transfer facilitator (220), may be handled by a local processor (270). This processor will generally operate with an operating system and control software and may operate in conjunction with, or instead of, the central control system (183), providing any control desired. Generally, the range of control will depend on the nature of the shelf module type. Simpler or more common shelf modules (such as those for storage) may be controlled by the central control system while more specialized systems may have almost autonomous local control requesting needed resources and essentially instructing the central control system (183) how to interact with them.

The engagement of mating connection plug (280) and connection plug (108) can allow for the provision of resources and/or communication from the shelf support structure (100) to the shelf module. The communications protocol for this connection will generally be Ethernet protocol, but can be other protocols as would be understood by one of ordinary skill in the art. The communications between local processor (270) and the onboard mechanisms will generally be through a direct connection. This protocol will typically be RS-232 although other protocols could be used as would be understood by one of ordinary skill in the art.

Power distribution, pneumatic circuitry, and electronic controls may be handled through the onboard control module (260). Electrical power, pneumatic supply, and other necessary resources will generally be received through the engagement of mating connection plug (280) and connection plug (108), although control module (260) may have access to onboard resources required by the particular shelf module, if desired. Control of the internal functions of the onboard control module (260) may be processed through a direct connection to local processor (270) or remotely.

In an embodiment, the onboard components of a shelf module, may be enclosed inside a self-contained environment. This type of arrangement can allow for a particular onboard mechanism, which may need a particular environment, to maintain that environment without having to have the entire shelf support structure (100) maintain that environment. Generally, if such an arrangement is used, there will be airlocks or similar mechanisms incorporated into the shelf module to allow for the objects to enter the shelf modules contained environment from transfer device (120) without significant loss of the contained environment. In a still further embodiment, the environment may be created by having individual shelf modules seal off sections of the shelf support structure (100) when installed. For instance, they may form a seal when inserted. In conjunction with a shelf module placed above them and a structure included as part of the transfer device (120) (such as a “window-shade” type structure which seals any area that the transfer device (120) is not currently accessing) the area above the shelf module and below the next shelf module may become a self contained environment simply through the installation of the shelf module and introduction of environmental resources.

Now that the general layout of a shelf module has been described, the exemplary shelf modules discussed above will be described to show how various processes can be accomplished by a shelf module. The first shelf modules which will be discussed are instrumentation shelf modules (200A) and (200B).

Instrumentation shelf modules (200A) and (200B) are designed to support, control, and transfer objects to and from benchtop laboratory instruments mounted as onboard mechanisms of the shelf module. Such laboratory instruments could include, but are not limited to, plate sealers, barcode labeler/applicators, plate seal piercers, liquid handling pipetters, liquid dispensers, plate washers, plate readers, shakers, centrifuges, heaters, dryers, bead stirrers, bead washers, illumination devices, barcode readers, plate carousels, or other similar instruments. The onboard instrument (209) in FIG. 10A is depicted as a traditional laboratory plate reader. That of FIG. 10B is depicted as four traditional thermal cyclers. As the thermal cyclers in FIG. 10B are significantly smaller than the laboratory plate reader of FIG. 10A, multiple of these instruments have been included in instrumentation shelf module (200B).

The instrumentation shelf modules (200A) and 200B) includes the general components of the shelf modules and a benchtop laboratory instrument (or instruments) as an onboard instrument (209). The instrument (209) will generally be clamped in place using locking clamps (210) or may, in an alternative embodiment, be permanently fastened down to the shelf plate (201) or attached using another method. This instrument (209) comprises one of the onboard mechanisms.

Instrumentation shelf modules (200A) and (200B) as shown in FIG. 10A and FIG. 10B will generally provide most of the processing capability of shelf support structure (100), as they can effectively provide any type of instrumentation which could be provided in a normal lab environment. Further, the only limitation on benchtop laboratory instruments which may be included are those limited by the dimensions of shelf support structure (100) allowing virtually any process which could be performed on a bench top surface, to be performed in the shelf support structure (100) providing the shelf support structure (100) is appropriately sized and/or arranged. It should be apparent, that such an arrangement can provide that a particular lab setup can take significantly less floor space (have a smaller footprint) than the same lab setup would require when placed in a traditional horizontal bench top arrangement. An instrumentation shelf module (200A) and (200B) will generally also include a transfer facilitator (220) as another onboard mechanism.

FIG. 11 shows an embodiment of a pipetting shelf module (1000). A pipetting shelf module (1000) will generally include a transfer facilitator (220) and a series of stations for acting on the physical object as its on-board mechanisms. In this case there are the stations (1001) and (1003). Station (1001) comprises a dispensing manifold for dispensing reagents into microtiter plates (121) and station (1003) comprises a pipetter for pipetting. The transfer facilitator (220) comprises a conveyor moving six plate positions (1005) through the two stations.

The pipetting shelf module (1000) also includes an on-board resource supply (1009) of reagents which may, in an embodiment, be maintained at specific temperatures, pressures, or other environmental factors either in conjunction with the rest of the pipetting shelf module (1000) or on their own. Temperature alteration of the reagents may be accomplished by the pipetting shelf module (1000) being provided with chilled or heated water from the central control system (183) which is then used to alter the temperature of reagent enclosure (1008) specific to this shelf module. As can further be seen in FIG. 11 while there are five sample microtiter plates present, there is also a box of replacement pipetter tips (1011) for restocking which may be transferred just like the microtiter plates. In still another embodiment, transfer facilitator (220) may be eliminated and a row of plates may be formed on the shelf module allowing a robotic pipetting arm to move over the row.

A stacker shelf module (400A) is shown in FIG. 13 and is designed to support and control a system to retrieve or dispense products to and from the shelf support structure (100). This is useful for loading and unloading consumable products such as pipette tips, microtiter plates etc. Additionally it could be used for loading and unloading actual samples to be processed within the overall system. Stacker shelf module (400A) provides that the onboard mechanisms load or unload removable stacks (308a) and (308b). In the depicted embodiment, two removable stacks (308a) and (308b) and associated assemblies are used, however other numbers of assemblies may be used and any or all of the assemblies may be placed in different orientations.

Removable stacks (308a) and (308b) act as sleeves to contain the products to be processed or consumed. These could be easily removed from the system, loaded by an operator with products to be processed or consumed by the process, and then reattached to the system. As depicted, the attachment points for these stacks will likely be external to the shelf support structure (100) enclosure. In an embodiment, removable stacks (308a) and (308b) have their own enclosure and environmental controls. This would be useful if incubation, refrigeration, humidification, or environmental constraints are required. Further, it would allow for independent control of each stack assembly (308a) or (308b), if required.

Generally there are two operations performed by the stacker shelf module (400A). The first is to retrieve product from the removable stacks (308a) and (308b) for use in the shelf support structure (100). For simplicity, the process to separate and retrieve a single product from the stack of products contained in one of the removable stacks (308a) is described. One of ordinary skill in the art would understand that any other stacks would generally operate in a similar manner.

A stacker lift mechanism (311A) is used to lower the product onto stacker conveyor (309a). Conveyor motor (310a) will then turn on and transport the product along stacker conveyor (309a). When the product is sensed at the appropriate position along stacker conveyor (309a) (such as through the use of optical or proximity sensors), the conveyor motor (310a) will generally be turned off to prevent the product from going over the end of the conveyor (310a). Transfer facilitator (220) will rotate as necessary and lower gripper (223) to pick up the object from the stacker conveyor (309a). Transfer facilitator (220) will then move up and swing back to place the object where it can be accessed by the transfer device (120). The object could now be sent to another shelf module.

The second operation allows for products to be dispensed to the stacks, for removal by an operator external to the shelf support structure. Again, this operation will be discussed in conjunction with removable stack (308a), however one of ordinary skill in the art would understand how the operation could be adapted for use with removable stack (308b). In order to deposit products into the removable stack (308a) from the shelf support structure (100), the following process takes place. The product is presented to the stacker shelf module (400A) by the transfer device (120). Transfer facilitator (220) will then rotate and lower to position gripper (223) about the product. The gripper (223) will close to grip the product. The gripper (223) will then raise the product slightly and then transfer facilitator (220) will rotate to the appropriate stacker conveyor (309a). The gripper (223) will then lower the product onto the stacker conveyor (309a). The gripper (223) will open and then raise to a clearance position. Conveyor motor (310a) will then turn on and transport the product along stacker conveyor (309a) to a position above the stacker lift mechanism (311a). The stacker lift mechanism (311a) will then raise the product into the removable stack (308a) where it may be held until unloaded by the operator. In an alternative embodiment, the transfer facilitator (220) may be removed and the transfer device (120) could interact directly with the appropriate stacker conveyor (309a) or (309b).

While stacker shelf module (400A) is depicted as sliding into shelf support structure (100) with the removable stacks (308a) and (308b) on the “forward” side of the shelf support structure, one of ordinary skill in the art would understand that the removable stacks (308a) and (308b) could be placed so as to be adjacent to any side of the shelf support structure (100). In this embodiment, the associated structures would also be rotated, although the position of transfer facilitator (220) may remain the same.

Shown in the embodiment of FIGS. 3-6. there is shown attached to the back of the shelf support structure (100) two hotel cabinets (400B) which may be stacker shelf modules having a different physical layout than that shown in FIG. 13. These hotel cabinets (400B) may be attached directly to the shelf support structure (100) without the use of the traditional shelf module while maintaining the functionality of the shelf support module in that they can connect to the network communication interface when attached and can be accessed by the transfer device to pick up or leave the physical objects, and can include self contained environments. The hotel cabinets (400B) are simply a different shape of shelf module having similar functionality to the stacker shelf module (400A), but designed to attach using a different type of connection other than the drawer rail system described above. The hotel cabinet (400B) therefore illustrates how the design of a shelf module may be altered without changing its functionality as a shelf module. In a still further embodiment, hotel cabinets (400B) could be permanently or removably attached to the shelf support structure (100) not forming shelf modules at all and lacking the communication and other features of a shelf module.

The next type of shelf module is conveyor shelf module (600A) shown in FIG. 12. This shelf module is conceptually similar to stacker shelf module (400A) but is generally designed to support and control a system to transport products to and from external instruments including other shelf support structures (100) as opposed to carrying the products to or from removable stacks (308a) and (308b). An embodiment of the transport between shelf support structures (100) utilizing conveyor module (600A) is shown in FIG. 3. Conveyor shelf module (600A) can also be used to automatically supply products to or from external instruments that would not fit within the physical space of shelf support structure (100) simplifying or eliminating the removal of the product from a removable stack (309a) or (309b) by a human operator to transport to a instrument outside the shelf support structure (100). Examples of such instruments may be large pipetters, incubators, or any type of instrument which may be too large to fit within shelf support structure (100), or that for some reason is not placed within a shelf support structure (100).

As depicted, a conveyor assembly (409) and a conveyor extension (413) are preferably used as the onboard mechanisms, however several of these assemblies may be used and they may be in different orientations, directions or positions. Because the system could be placed at any shelf position within shelf support structure (100), any height position of the conveyor (409) could be achieved by adjusting the relative height position with mounting brackets (210).

Conveyor extension (413) is preferably used for two reasons. The first is that having conveyor extension (413) being removable from conveyor (409) at a point above the surface of shelf plate (201) allows for the conveyor shelf module (600A) to be more easily slid in and out of shelf support structure (100) on shelf guides (206) even if the net transport of the product is supposed to go out the side of shelf support structure (100) (over the drawer guides (106)). If the conveyor extension (413) were permanently attached, the resulting conveyor may not clear the frame of shelf support structure (100) and would have to be permanently affixed in the shelf support structure (100). Such permanence constitutes another embodiment of the invention and is shown in an alternative embodiment in FIG. 6. In this embodiment, the functionality of the conveyor shelf module (600A) is maintained in fixed conveyor(s) (181) attached to the rear or the shelf support structure (100). The fixed conveyor may be at a fixed location, or may be attachable. In an embodiment, the conveyor of FIG. 6 could, like the hotel cabinet (400B) simply comprise an alternatively shaped shelf module whereby the conveyor (181) includes a mating connection plug (280) or similar structure to connect to the network communication infrastructure. Such a shelf module is shown as a conveyor shelf module (600B) of alternative design to conveyor shelf module (600A).

In an alternative embodiment, conveyor extension may not be present at all. In one such alternative embodiment, the conveyor (409) is actually designed so as to replace conveyor extension (413). In particular, there would generally be included a mechanism to extend conveyor (409) or shift conveyor (409) from a position seated entirely on shelf plate (201) to a position where it overhangs a portion of shelf plate (201). In this way the conveyor extension (413) is effectively unnecessary as conveyor (409) provides for similar functionality.

Regardless of whether conveyor shelf module (600A), conveyor shelf module (600B) or a fixed conveyor (181) is used, in order to retrieve a product from an external instrument or another shelf support structure (100), a sensor or other system to detect a product ready for conveyance into the shelf support structure (100) may be used. This will be discussed presuming that conveyor shelf module (600A) is being used. Products are generally brought into the system on conveyor (409) through control of conveyor motor (410). When the product is sensed at the appropriate position along conveyor (409), the conveyor motor (410) will be turned off. Transfer facilitator (220) will then rotate as necessary and lower gripper (223) to pick up the object from the conveyor (409). The transfer facilitator (220) will then move up and swing back to its original position and provide the object to transfer device (120). The object could now be sent to another shelf module. In alternative embodiments, the transfer device (120) may obtain the object directly from the conveyor.

To provide a product currently in this shelf support structure (100) to another shelf support structure (100) or to an external instrument, the following process generally takes place. The product is presented to the conveyor shelf module (600A) by the transfer device (120). Transfer facilitator (220) will then rotate and lower to position gripper (223) about the product. The gripper (223) will close to grip the product. The gripper (223) will then raise the product slightly and then transfer facilitator (220) will rotate to the conveyor (409). The gripper (223) will then lower the product onto the conveyor (409), the gripper (223) will open and then raise to a clearance position. Conveyor motor (410) will then turn on and transport the product along conveyor (409).

Conveyor (409) may be any type of conveyor known to those of skill in the art including, but not limited to, endless belt conveyors, walking beam conveyors, or link conveyors. Conveyor extension (413) will generally be an extension of conveyor (409). In the depicted embodiment the conveyor extension (413) is straight, but in another embodiment it may be curved or angled. In the depicted embodiment conveyor extension (413) may be powered by its own motor (415) and may use a similar or different method of conveyance as conveyor (409). In still another embodiment, the conveyor extension (413) may be unpowered and effectively be a “deadplate,” as that term is understood by those of skill in the art, allowing for a connection between conveyor (409) and an external conveyor. In either case, the product will generally leave conveyor (409) and arrive at conveyor extension (413) at which time the product is generally outside the confines of shelf support structure (100), and may be delivered to an external instrument, another shelf support structure (100), and or to an additional conveyor. A sensor or other acknowledgement system may be incorporated to determine when the process has completed or to determine when there is product on conveyor extension (413).

One of ordinary skill in the art would understand that the conveyor extension (413) is an optional piece which can be used to simply provide for additional extension of the conveyor (409) to reach the instrument to which the product is being transported. In another embodiment the conveyor extension (413), could actually be part of a traditional horizontal conveyor system which could be used to remove completed products from the shelf support structure (100) and the vertical integration platform and transport them to a physically separate area for evaluation or further processing.

In still another embodiment, the conveyor extension can be enclosed in an enclosure to prevent loss of atmosphere inside the shelf support structure when a product passes over conveyor extension (413). In particular, conveyor extension (413) could effectively provide for an “airlock” which can be activated by the host computer (150) or local processor (270). In order to provide such a system, the attachment to the conveyor extension (413) may also involve connecting a mating connection plug (280) to a connection plug (280) on the shelf support structure (100), or on the conveyor shelf module (600A) to indicate that such an airlock mechanism is in place. In this way, a product can be transported from one self-contained environment to another without significant loss of either environment which can lead to the system being more efficient. Further, on-board control module (260) may include monitors that recognize that such an airlock system must be in place if a conveyor shelf module is attached and the environment inside the shelf support structure (100) is being controlled. Any or all of the above functionality may also alternatively and/or additionally be provided through the use of fixed conveyors or alternatively shaped shelf modules designed for conveying.

FIGS. 14A and 14B provide for embodiments of storage shelf modules (800A) and (800B). A storage shelf module (800A) and/or (800B) generally provides that the physical objects in the system can be stored and retrieved within in the shelf support structure (100) and do not need to be removed. Essentially, a storage shelf module may simply be an alternatively arranged stacker shelf module (400A) or (400B). In particular, this allows for products which need to be both stored and processed in a specific environment to be placed in the shelf support structure (100), and not removed until complete by utilizing a storage rack and/or identification system as onboard mechanisms. In further embodiments, the storage area may have a change of environment during storage to provide for such a function in the system. The storage shelf module could also be accessed by an operator to either load or remove consumables from the system that may be placed in the storage. In FIGS. 14A and 14B, the storage shelf modules (800A) and (800B) depicted are of a carousel-type however two different designs are shown. A carousel provides for a rotating storage rack. One of skill in the art would understand, however, that storage need not be rotating, but could instead be shelved linearly, stacked, or utilize any other type of storage arrangement.

Storage shelf modules (800A) and (800B) are designed to automatically store and retrieve products to be used and/or processed in the shelf support structure (100) (or any connected shelf support structures (100) in that embodiment of the system). Products may be manually inserted into the storage rack, or alternatively may be automatically stored as described below. Products will generally automatically be retrieved from the storage rack when requested by the central control system (183). The remaining discussion will relate to storage shelf module(s) specifically having the carousel configuration (of FIGS. 14A and 14B), but one of ordinary skill in the art would understand how this discussion could be adapted to any other type of storage shelf module.

The storage shelf modules (800A) and (800B) may perform a variety of tasks to determine what is currently stored and what is available in the storage shelf module (800A) and/or (800B). One of these tasks allows for the module to automatically inventory its contents. This is particularly useful where the shelf support structure (100) is under controlled conditions as it allows for a check to make sure all inventory is correctly known without loss of the environmental conditions. This process would generally be begun by the operator initiating an “inventory check” through software running on the host computer (150). This would cause the storage shelf module (800A) or (800B) to check for products stored in the product holding positions (501) within carousel disk(s) (509). If a product is identified to be in a particular position, its barcode value will be read with a barcode reader which may be mounted on transfer facilitator (220) or elsewhere on shelf base (201). The data will then be updated into a local database held in the local processor (270) or the data may be transferred to the host computer (150). The carousel disk(s) (509) is then rotated about carousel axis (508) by carousel drive motor (511) until the next product holding position (501) is in position to be checked. This process repeats until all product holding positions (501) are checked for the particular carousel disk(s) (509). The transfer facilitator (220) then moves to the next vertical position to align to the remaining carousel disk(s) (509). The process repeats until all product holding positions (501) on all the carousel disk(s) (509) have been checked and the data is updated.

Product can be placed into the storage system either manually (such as by preloading a series of products upon which the vertical integration platform will operate) or can be loaded automatically by the storage shelf module (800A) or (800B) and other components in the shelf support structure (100). In the latter case, the products may enter the shelf support structure (100) through a conveyor shelf module (600A), a stacker shelf module (400A), or any other shelf module or fixed system as discussed above. In the automatic case, the product is presented to the storage shelf module (800A) or (800B) by the transfer device (120). In the depicted embodiment, the transfer device's (120) transport portion (122) is actually used to place the object in the carousel disk (509).

Transfer device (120) will rotate, slide, or otherwise move to secure the object. The local processor (270) will examine its database for an available product holding position (501). Once this position is determined, the carousel disk(s) (509) are rotated about carousel axis (508) by carousel drive motor (511) until the identified product holding position (501) is properly aligned to be accessed by the transfer device (120). The transfer device (120) may raise or lower to vertically align to the correct carousel disk(s) (509). The transfer device (120) will then insert the product into the product holding positions (501) and the gripper (or spatula) will release the product. The barcode of the product may then be read and updated into the local database.

Like storage of products, a product can also be automatically retrieved when requested. In order to retrieve the product from the storage shelf module (800A) or (800B), the host computer (150) will generally request a specific product or product type from the storage shelf module (800A) or (800B). The local processor (270) will then examine its database to determine the appropriate product holding position (501) of a product responsive to the request. Once this position is determined, the carousel disk(s) (509) are rotated about carousel axis (508) by carousel drive motor (511) until the identified product holding position (501) is properly aligned for access by the transfer device (120). Transfer device (120) will raise or lower to vertically align to the correct carousel disk(s) (509). A barcode value may be verified. Transfer device (120) will then rotate and lower to be adjacent the product. The gripper will close to grip the product (or capture from underneath in the case of a spatula). Transfer device (120) will then carry the object to another shelf module.

Although a barcode reader is discussed in conjunction with FIGS. 14A and 14B, one of ordinary skill in the art would understand that it is an optional mechanism. Products need not be identified by an attached barcode, but may be remembered by product holding position (501). For instance, the storage shelf module (800A) or (800B) may know the type of product at a particular position, and know that if requested that product is presented to the transfer device (120). Alternatively, a bar code mechanism may have its own shelf module, or be located elsewhere in the shelf storage structure (100).

FIG. 15 provides for additional detail and description related to the transfer facilitator (220) used to transport products on a shelf module. FIG. 15 demonstrates the major components of a transfer facilitator (220) as viewed from three different directions. The Z-axis is preferably a servo driven lead screw actuator to move the arm (630) up or down vertically (Z direction). This Z-axis is affixed to a rotational cylinder (620). Rotational cylinder (620) is preferably pneumatic and can rotate the arm through an angle set with the angle end stop adjustment bolts (670). Gripper cylinder (640) is affixed to the arm (630) at the gripper rotational axis (680). This axis can rotate through a gripper angle. The gripper cylinder (640) has two gripper fingers (623) attached, which can move linearly. These gripper fingers (623) are likely to have various configurations but will generally be combined to form gripper (223). The hex shaft (660) is designed to insert into an aperture in the shelf plate (201), or alternately it could be retracted. The positioning will generally depend on the type of motion desired. Hex shaft (660) is mechanically linked to the gripper rotational axis (680) using belts, pulleys, shafts, and sleeves.

The drawings of the transfer facilitator (220) provided herein are only one example of how such an arm might work. The system could use any type of robot arm including standard full function robot arms as known to those of ordinary skill in the art. Other configurations may also be used which include, but are not limited to, assemblies of pneumatic cylinders, hydraulic cylinder, servo driven actuators, stepper driven actuators, DC motor driven actuators, conveyors or any combination of these.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. An automated processing system comprising;
a shelf support structure including:
a network communication infrastructure,
a central control system connected to said infrastructure, and
a transfer device connected to said infrastructure; and
a shelf module including:
at least one mechanism for manipulating a physical object provided to said shelf module, and
a network interface allowing said shelf module to connect to said network communication infrastructure;
wherein each of said shelf modules can be supported by said shelf support structure in such a manner that said network interface connects to said network communication infrastructure;
wherein said central control system can automatically recognize said at least one mechanism via said network communication infrastructure once said shelf module is connected to said network communication infrastructure; and
wherein said central control system can utilize said transfer device to provide said physical object to said shelf module so that said at least one mechanism can manipulate said physical object.

2. The system of claim 1 wherein said physical object comprises a microtiter plate.

3. The system of claim 1 wherein said shelf support structure comprises a cabinet.

4. The system of claim 3 wherein said shelf support structure includes a contained environment.

5. The system of claim 1 wherein said network communication infrastructure comprises a wired network including a connection plug.

6. The system of claim 5 wherein said network interface comprises a mating connection plug designed to mate with said connection plug.

7. The system of claim 6 wherein said mating connection plug mates with said connection plug when said shelf module is pushed into said shelf support structure.

8. The system of claim 1 wherein said shelf support structure is designed to support a plurality of said shelf modules in a vertical arrangement.

9. The system of claim 8 wherein said transport device comprises a vertical lift.

10. The system of claim 9 wherein said vertical lift comprises a vertical conveyor.

11. The system of claim 9 wherein said vertical lift comprises a robot arm.

12. The system of claim 11 wherein said robot arm has at least three dimensions of motion.

13. The system of claim 1 wherein said transport device comprises a robot arm.

14. The system of claim 1 wherein said at least one mechanism on said shelf module comprises at least one of, a robot arm, a transfer facilitator, a stack, a carousel, an instrument, and a station.

15. The system of claim 1 wherein said shelf module includes a self-contained environment to that shelf module.

16. The system of claim 1 wherein said automated processing system can be mated to a second automated processing system and physical objects can be passed between said automated processing system and said second automated processing system.

17. The system of claim 18 wherein said central control system of said automated processing system can also control the central control system of said second automated processing system when said systems are so mated.

18. The system of claim 1 wherein said system can pass through a 36″ by 84″ doorway without disassembly

19. The system of claim 1 further comprising at least one of: an external conveyor, an external storage rack, and an emergency shutoff.

20. The system of claim 1 wherein said physical object includes at least one of: a biological sample, a tube, and a pipette tip.

21. The system of claim 1 wherein said network communication infrastructure comprises an Ethernet protocol computer network infrastructure.

22. The system of claim 1 wherein said automated processing system comprises at least one vertical integration platform.

23. A shelf module comprising:
at least one mechanism for manipulating a physical object provided to said shelf module; and
a network interface allowing said shelf module to connect to a network communication infrastructure;
wherein said shelf module can be supported in a shelf support structure in such a manner that said network interface connects to said network communication infrastructure in said shelf support structure;
wherein said shelf module can automatically identify itself to a central control system in said shelf support structure once said shelf module is connected to said network infrastructure; and
wherein said shelf module can receive physical objects from a transfer device in said shelf support structure.
